(19) United States
(12) Patent Application Publication
(10) Pub. No.: US 2025/0157765 A1
(43) Pub. Date: May 15, 2025

(54) PROTECTING DEVICE AND BATTERY PACK

(71) Applicant: DEXERIALS CORPORATION, Tochigi (JP)

(72) Inventors: Yuji KIMURA, Tochigi (JP); Chisato KOMORI, Tochigi (JP); Atsuya YOSHINARI, Tochigi (JP)

(73) Assignee: DEXERIALS CORPORATION, Tochigi (JP)

(21) Appl. No.: 18/729,510

(22) PCT Filed: Dec. 26, 2022
(86) PCT No.: PCT/JP2022/048058

§ 371 Date: Jul. 17, 2024

(30) Foreign Application Priority Data
Jan. 20, 2022 (JP) 2022-007497

(51) Int. Cl. H01H 37/76; H01H 37/04; H01H 37/34; H02J 7/00

(52) U.S. Cl. CPC H01H 37/761; H01H 37/04; H01H 37/34; H02J 7/00302; H02J 7/00306; H02J 7/0031; H02J 7/0047

(57) ABSTRACT

Provided is a protecting device with a built-in heat generator that can handle higher voltages and higher currents and blows the current path more safely and quickly without causing damage inside the device. The protecting device includes: a fuse element 2 and a blowing member 3, and the blowing member 3 includes an insulating substrate 4, a heat generator 5, an insulating layer 6 covering the heat generator 5, a heat-generator lead-out electrode 7 superimposed with the heat generator 5 via the insulating layer 6, and a heat-dissipating portion 8 formed on the front surface 4a side of the insulating substrate 4 at least in an area superimposed with the heat generator 5 and is electrically independent from the heat-generator lead-out electrode 7, a holding electrode 10 formed on the back surface 4b of the insulating substrate 4 and holds the melted conductor 2a of the fuse element 2, and a through-hole 11 connecting the heat-generator lead-out electrode 7 and the holding electrode 10, the fuse element 2 being connected to the holding electrode 10.

### TECHNICAL FIELD

This technology relates to a protecting device for interrupting a current path and a battery pack using the same. This application claims priority based on JP 2022-007497 filed in Japan on Jan. 20, 2022, which is hereby incorporated by reference into this application.

### BACKGROUND ART

Secondary batteries are often provided to users in the form of rechargeable battery packs which can be repeatedly used. In particular, in order to protect users and electronic appliances, lithium ion secondary batteries having a high volumetric energy density typically include several protective circuits incorporated in battery packs for over-charging protection and over-discharging protection to interrupt the output of the battery pack under predetermined conditions.

Many electronic devices using lithium-ion rechargeable batteries use an FET switch incorporated in a battery pack to turn ON/OFF the output, for over-charging protection or over-discharging protection of the battery pack. However, even in the cases of the FET switch being short-circuited and damaged for some reason, a large current caused by a surge such as lighting momentarily flowing, or an abnormally decreased output voltage or an excessively high output voltage occurring in an aged battery cell, the battery pack or the electronic appliance should prevent accidents including fire, among others. For this reason, a protective element is used having a fuse device that interrupts a current path in accordance with an external signal so as to safely interrupt the output of the battery cell under these possible abnormalities.

As a protecting device in the protecting circuit for lithium-ion secondary batteries and the like, a structure having a heat generator inside the protecting device is used which blows out the meltable conductor on the current path by the heat generated by the heat generator.

Applications of lithium-ion rechargeable batteries have been expanding in recent years, and they are beginning to be used in larger current applications, such as electric power tools such as electric drivers, and transportation equipment such as hybrid cars, electric cars, and electrically power-assisted bicycles, and drones. In these applications, particularly at startup, a large current exceeding several tens to a hundred Ampere may flow. It is desired to implement a protecting device compatible with such a large current capacity.

In order to implement a protecting device compatible with such a large current, there is proposed a protecting device including a meltable conductor having an increased sectional area and an insulating substrate having a heat generator formed thereon and connected to a surface of the meltable conductor.

FIG. 39 is a cross-sectional view of a conventional protecting device. The protecting device 100 shown in FIG. 39 includes a fuse element 101 and a pair of blowing members 102 that blow the fuse element 101.

FIG. 40 shows the blowing members in which FIG. 40A is a plan view of the front surface of the insulating substrate on which the heat generator is installed, and FIG. 40B is a bottom view of the back surface of the insulating substrate in contact with the fuse element 101. Each blowing member 102 includes an insulating substrate 103, a heat generator 104 formed on the front surface of the insulating substrate 103, an insulating layer 105 covering the heat generator 104, a heat-generator lead-out electrode 106 connected to the heat generator 104 and superimposed with the heat generator 104 through the insulating layer 105, a holding electrode 107 formed on the back surface of the insulating substrate 103 which holds the melted conductor of the fuse element 101 when the fuse element 101 is blown, and a through-hole 108 that penetrates through the insulating substrate 103 and connects the heat-generator lead-out electrode 106 and the holding electrode 107.

The heat generator 104 is connected to an external circuit with a power supply via a heat-generator feeding electrode 110 and can be powered by the external circuit.

The fuse element 101 is connected to the first and second electrode terminals 111, 112 connected to the external circuit by a bonding material such as connecting solder 114. The fuse element 101 is also connected to the holding electrode 107 and the auxiliary electrode 109 formed on the back surface of the insulating substrate 103 by a bonding material such as the connecting solder 114.

When the heat generator 104 is energized and heated, the blowing members 102 melt the fuse element 101 by this heat and sucks the melted conductor 101a through the through-hole 108 to the heat-generator lead-out electrode 106 side. As a result, the fuse element 101 is blown between the holding electrode 107 and the auxiliary electrode 109, thereby interrupting the conduction between the first and second electrode terminals 111 and 112.

### CITATION LIST

### Patent Literature

Patent Document 1: JP 2020-173965 A

### SUMMARY OF INVENTION

### Technical Problem

In the conventional structure of the protecting device 100 shown in FIG. 39, when used in a protection circuit for high-voltage, high-current applications such as electric vehicles, the fuse element 101 with a large cross-sectional area corresponding to the large current is used, and when the protecting device 100 works, in order to quickly blow the fuse element 101, a high voltage is applied to the heat generator 104, which generates high heat.

Therefore, a temperature difference occurs in the insulating substrate 103 due to the difference in thermal conductivity between the area with the heat-generator lead-out electrode 106 and the other area, and the insulating substrate 103 or the heat generator 104 may be damaged due to stress. In other words, as shown in FIG. 42A, the heat from the heat generator 104 is dispersed and transferred to the insulating substrate 103 and the heat-generator lead-out electrode 106 in the area where the heat-generator lead-out electrode 106 is formed, so the insulating substrate 103 is not locally overheated. On the other hand, in the area R where the heat-generator lead-out electrode 106 is not formed, heat from the heat generator 104 is transferred only to the insulating substrate 103, resulting in overheating compared to the area where the heat-generator lead-out electrode 106 is formed. This may cause stress due to uneven heat distribution on the insulating substrate 103, which may damage the insulating substrate 103 and the heat generator 104.

This may increase the time it takes to blow the fuse element 107, making it impossible to quickly and safely interrupt the current path, and may also cause the heat generator 104 to stop heating in an uncut condition, as shown in FIG. 42B and FIG. 41. FIG. 43A is a cross-sectional view taken along line A-A′ of the blowing member 102 shown in FIGS. 42A and 42B. FIG. 43B is a cross-sectional view taken along line B-B′ of the blowing member 102 shown in FIGS. 42A and 42B.

The risk that the fuse element 101 will remain unfused due to damage to the insulating substrate 103 or the heat generator 104, thus preventing current interruption, increases as the fuse element 101 becomes larger at higher voltages and higher currents, as the current rating and electric field strength increase, and as the insulating layer 105 becomes thinner to make the protecting device 100 smaller.

Therefore, there is a need to protect devices with built-in heat generators that can handle higher voltages and currents and operate more safely and quickly without causing damage inside the device.

Therefore, an object of the present technology is to provide a protecting device capable of preventing damage inside the device even when high voltage is applied and interrupting the current path safely and quickly, and a battery pack using the same.

### Solution to Problem

In order to solve the above-described problems, a protecting device of the present technology includes: a fuse element and a blowing member for blowing the fuse element, wherein the blowing member includes: an insulating substrate; a heat generator formed on the front surface of the insulating substrate; an insulating layer covering the heat generator; a heat-generator lead-out electrode connected to the heat generator and superimposed with the heat generator via the insulating layer; a heat-dissipating portion formed on the front surface of the insulating substrate, at least in an area superimposed with the heat generator, and electrically independent from the heat-generator lead-out electrode; a holding electrode formed on the back surface of the insulating substrate that is the reverse side of the front surface to hold the melted conductor of the fuse element when the fuse element is blown; and a through-hole connecting the heat-generator lead-out electrode and the holding electrode, wherein the fuse element is connected to the holding electrode.

A protecting device of the present technology includes: a fuse element and a blowing member for blowing the fuse element, wherein the blowing member includes: an insulating substrate; a heat generator formed on the front surface of the insulating substrate; an insulating layer covering the heat generator; a heat-generator lead-out electrode connected to the heat generator and superimposed with the heat generator via the insulating layer; a heat-dissipating portion formed on the front surface of the insulating substrate, at least in an area superimposed with the heat generator, and electrically independent from the heat-generator lead-out electrode; a holding electrode formed on the back surface of the insulating substrate that is the reverse side of the front surface to hold the melted conductor of the fuse element when the fuse element is blown; and a through-hole connecting the heat-generator lead-out electrode and the holding electrode, wherein the fuse element is connected to the heat-generator lead-out electrode.

A protecting device of the present technology includes: a fuse element and a blowing member for blowing the fuse element, wherein the blowing member includes: an insulating substrate; a heat generator formed on the front surface of the insulating substrate; an insulating layer covering the heat generator; a heat-generator lead-out electrode connected to the heat generator and superimposed with the heat generator via the insulating layer; a heat-dissipating portion formed on the front surface of the insulating substrate, at least in an area superimposed with the heat generator, and electrically independent from the heat-generator lead-out electrode; and a first electrode and a second electrode formed on the front surface of the insulating substrate and connected to an external circuit, wherein the fuse element is connected to the first electrode, the second electrode, and the heat-generator lead-out electrode provided between the first and second electrodes.

A protecting device of the present technology includes: a fuse element and a blowing member for blowing the fuse element, wherein the blowing member includes: an insulating substrate; a heat generator formed on the front surface of the insulating substrate; an insulating layer covering the heat generator; a heat-generator lead-out electrode superimposed with the heat generator on the back surface of the insulating substrate and connected to the heat generator; a heat-dissipating portion formed on the back surface of the insulating substrate at least in an area superimposed with the heat generator, and electrically independent from the heat-generator lead-out electrode; and a first electrode and a second electrode formed on the back surface of the insulating substrate and connected to an external circuit, wherein the fuse element is connected to the first electrode, the second electrode, and the heat-generator lead-out electrode.

A protecting device of the present technology includes: a fuse element and a blowing member for blowing the fuse element, wherein the blowing member includes: an insulating substrate; a plurality of heat generators provided in parallel on the front surface of the insulating substrate; an insulating layer covering the heat generators; a heat-generator lead-out electrode connected to the heat generators and superimposed with the heat generators via the insulating layer; a heat-dissipating portion formed on the front surface of the insulating substrate, at least in an area superimposed with the heat generators, and electrically independent from the heat-generator lead-out electrode; a first electrode and a second electrode formed on the back surface of the insulating substrate and connected to an external circuit; a holding electrode provided between the first and second electrodes on the back surface of the insulating substrate; a through-hole penetrating the area between the plurality of heat generators of the insulating substrate and connecting the heat-generator lead-out electrode and the holding electrode, wherein the fuse element is connected to the first electrode, the second electrode, and the holding electrode.

A battery pack according to the present technology includes one or more battery cells and a protecting device connected on the charging/discharging path of the battery cells to interrupt the charging/discharging path, and the protecting device is the protecting device described in any of the above.

### Advantageous Effects of Invention

According to the present technology, since a heat-dissipating portion is formed at least in an area superimposed with the heat generator, uneven heat distribution caused by heating the heat generator on the insulating substrate is reduced. This prevents damage to the insulating substrate and the heat generator due to stress caused by uneven heat distribution, and allows the fuse element to melt safely and quickly even when a high voltage is applied to the heat generator.

### BRIEF DESCRIPTION OF DRAWINGS

FIG. 1 is a plan view of a protecting device according to the present technology.

FIG. 2 is a cross-sectional view of the protecting device according to the present technology taken along line D-D′ shown in FIG. 1.

FIG. 3 shows a blowing member, in which FIG. 3A is a plan view of the front surface of the insulating substrate, and FIG. 3B is a bottom view of the back surface of the insulating substrate.

FIG. 4 is a plan view of a blowing member in which the base portion of a heat-generator lead-out electrode is formed not only on the insulating layer but also on both edges of the insulating substrate.

FIG. 5 shows a blowing member with an insulating coating layer covering the heat-dissipating portion, in which FIG. 5A is a plan view of the surface of the insulating substrate, and FIG. 5B is a cross-sectional view.

FIG. 6 is a plan view of a blowing member with a heat-dissipating portion formed as widely as possible.

FIG. 7 shows a state in which the fuse element is melted in the protecting device according to the present technology, in which FIG. 7A is a cross-sectional view taken along line A-A′ shown in FIG. 8, and FIG. 7B is a cross-sectional view taken along line B-B′ shown in FIG. 8.

FIG. 8 shows a state in which the fuse element is blown in the protecting device according to the present technology, in which FIG. 8A is a plan view, and FIG. 8B is a bottom view.

FIG. 9 is a circuit diagram of a protecting device according to the present technology.

FIG. 10 is a cross-sectional view of a protecting device according to the present technology, showing the state in which the fuse element is blown.

FIG. 11 is a cross-sectional view of a fuse element.

FIG. 12 is a plan view of a fuse element in which blowing members are connected to one side and the other side of the fuse element.

FIG. 13 is a circuit diagram of an example configuration of a battery pack.

FIG. 14 is a cross-sectional view of a modification of a protecting device with a protruding portion on the case.

FIG. 15 is a plan view of a modification of a protecting device with a protruding portion on the case.

FIG. 16 is a cross-sectional view of a modification of a protecting device with a heat-dissipating element on the heat-dissipating portion.

FIG. 17 is a plan view of a modification of a protecting device with a heat-dissipating element on the heat-dissipating portion.

FIG. 18 is a perspective view of a blowing member with a heat sink as a heat-dissipating element on the heat-dissipating portion.

FIG. 19 is a cross-sectional view of a modification of a protecting device according to the present technology.

FIG. 20 shows the blowing member of the protecting device of the modification shown in FIG. 19, in which FIG. 20A is a plan view, and FIG. 20B is a bottom view.

FIG. 21 shows a modification of a protecting device according to the present technology, in which FIG. 21A is a plan view, FIG. 21B is a cross-sectional view, and FIG. 21C is a bottom view.

FIG. 22 shows the state in which the fuse element is blown in the protecting device shown in FIG. 21, in which FIG. 22A is a plan view, and FIG. 22B is a cross-sectional view.

FIG. 23 is a plan view of a modification of the protecting device shown in FIG. 21 in which the heat-dissipating portion is formed only on the insulating layer 6.

FIG. 24 is a plan view of a modification of the protecting device shown in FIG. 21 in which the heat-dissipating portion is formed as widely as possible over the area where no other electrodes are formed.

FIG. 25 is a circuit diagram of the protecting device shown in FIG. 21.

FIG. 26 shows a modification of a protecting device according to the present technology, in which FIG. 26A is a plan view, FIG. 26B is a cross-sectional view, and FIG. 26C is a bottom view.

FIG. 27 shows a modification of the protecting device shown in FIG. 26 with an insulating coating layer covering the heat-dissipating portion, in which FIG. 27A is a plan view, and FIG. 27B is a cross-sectional view.

FIG. 28 is a plan view of the protecting device shown in FIG. 26, showing a modification in which the heat-dissipating portion is formed as widely as possible over the area where no other electrodes are formed.

FIG. 29 is a plan view of the protecting device shown in FIG. 28 with an insulating coating layer covering the heat-dissipating portion.

FIG. 30 shows a modification of the protecting device shown in FIG. 26 with a second heat-dissipating portion, in which FIG. 30A is a cross-sectional view, and FIG. 30B is a plan view.

FIG. 31 is a plan view of a blowing member in which the guiding electrode is not formed and the heat-dissipating portion is widened as much as possible.

FIG. 32 shows a modification of a protecting device according to the present technology, in which FIG. 32A is a plan view, and FIG. 32B is a bottom view.

FIG. 33A is a cross-sectional view taken along line A-A′ of FIG. 32A, and FIG. 33B is a cross-sectional view taken along line B-B′ of FIG. 32A.

FIG. 34 is a circuit diagram of the protecting device shown in FIG. 32.

FIG. 35 shows the state in which the fuse element is blown in the protecting device shown in FIG. 32, in which FIG. 35A is a plan view, and FIG. 35B is a bottom view.

FIG. 36A is a cross-sectional view taken along line A-A′ of FIG. 35, and FIG. 36B is a cross-sectional view taken along line B-B′ of FIG. 35.

FIG. 37 is a cross-sectional view of a modification of a protecting device according to the present technology.

FIG. 38 shows the protecting device shown in FIG. 37, in which FIG. 38A is a plan view, and FIG. 38B is a bottom view.

FIG. 39 is a cross-sectional view of an example of a conventional protecting device.

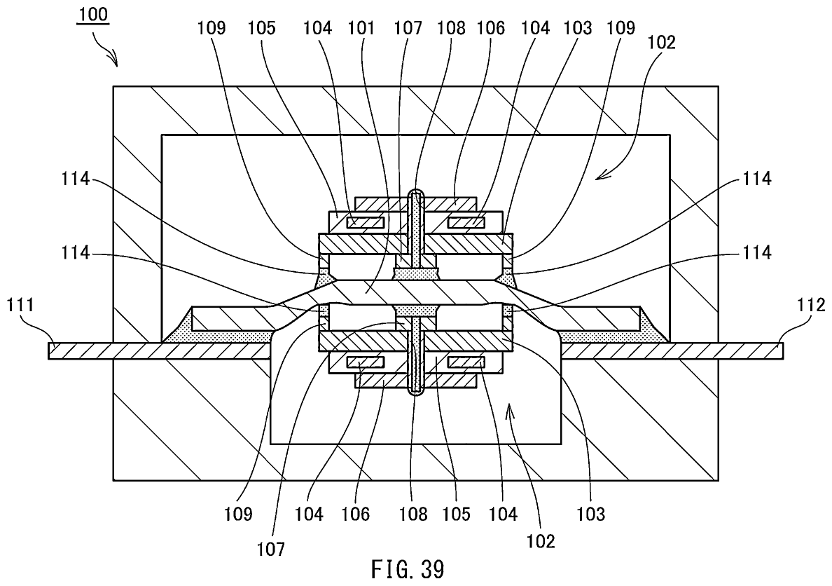

FIG. 40 shows the blowing member, in which FIG. 40A is a plan view of the front surface of an insulating substrate with a heat generator, and FIG. 40B is a bottom view of the back surface of the insulating substrate in contact with a fuse element.

FIG. 41 is a cross-sectional view of a state in which the fuse element is partially uncut in the protecting device shown in FIG. 40.

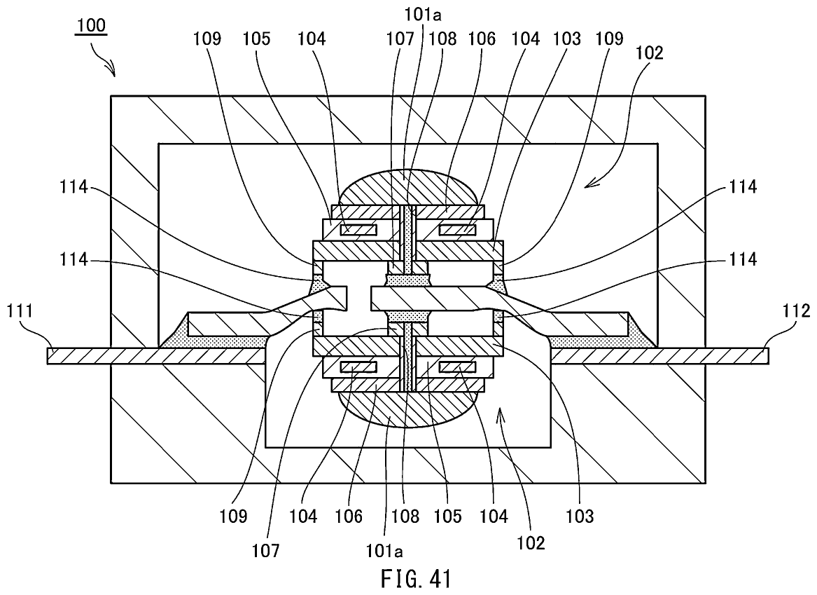

FIG. 42 shows a state in which the fuse element is uncut in the protecting device shown in FIG. 40, in which FIG. 42A is a plan view, and FIG. 42B is a bottom view.

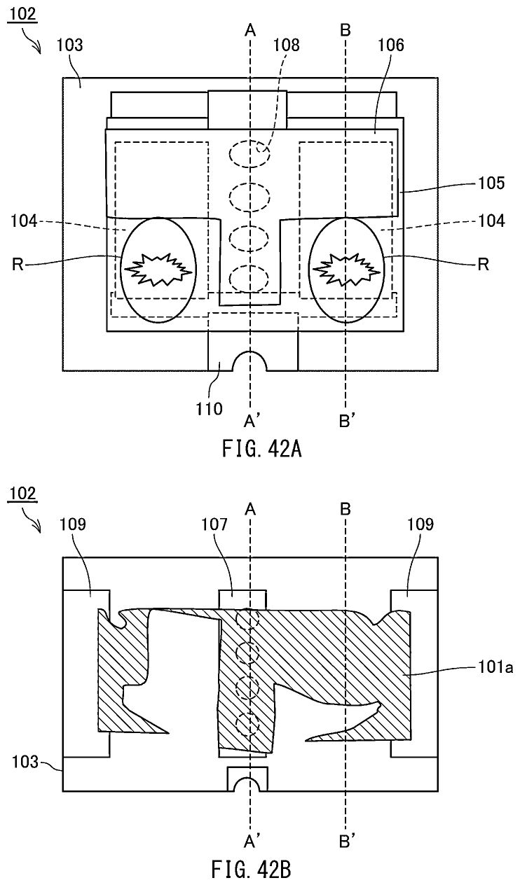

FIG. 43A is a cross-sectional view of the blowing member taken along line A-A′ shown in FIGS. 42A and 42B. FIG. 43B is a cross-sectional view of the blowing member taken along line B-B′ shown in FIGS. 42A and 42B.

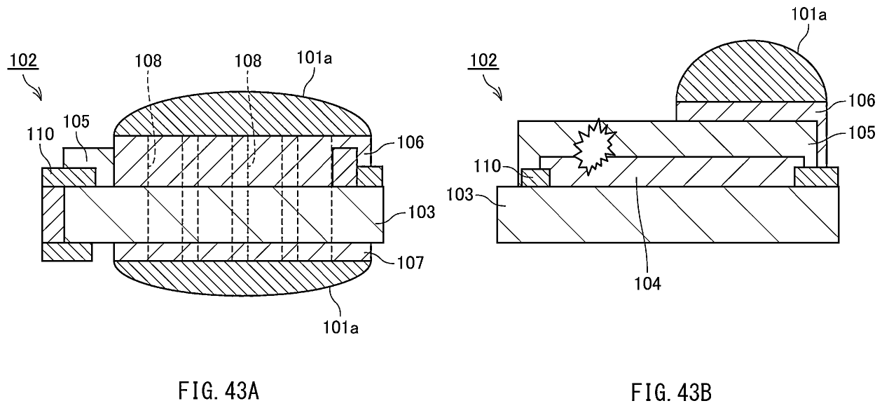

### DESCRIPTION OF EMBODIMENTS

Embodiments of a protecting device according to the present technology and a battery pack using the same will now be more particularly described with reference to the accompanying drawings. It should be noted that the present technology is not limited to the embodiments described below and various modifications can be added to the embodiment without departing from the scope of the present technology. The features shown in the drawings are illustrated schematically and are not intended to be drawn to scale. Actual dimensions should be determined in consideration of the following description. Moreover, those skilled in the art will appreciate that dimensional relations and proportions may be different among the drawings in some parts.

### Protecting Device

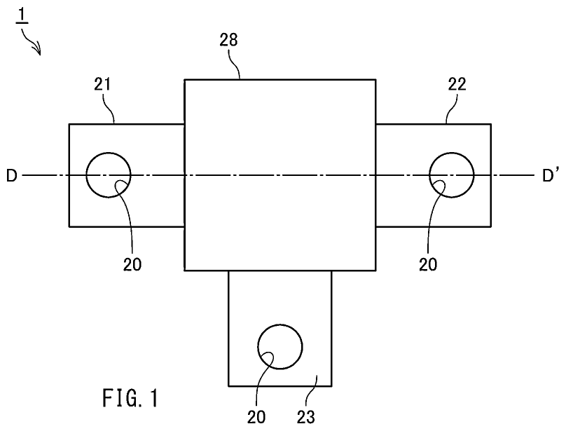

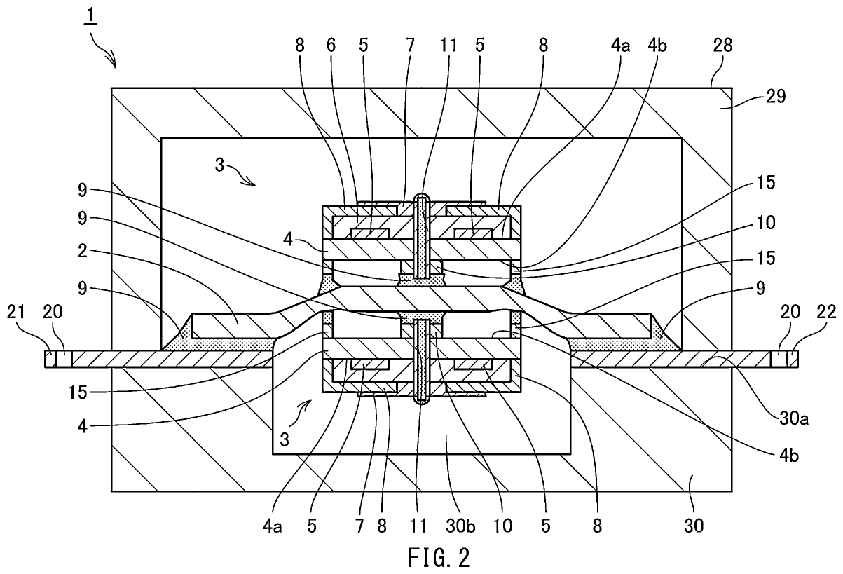

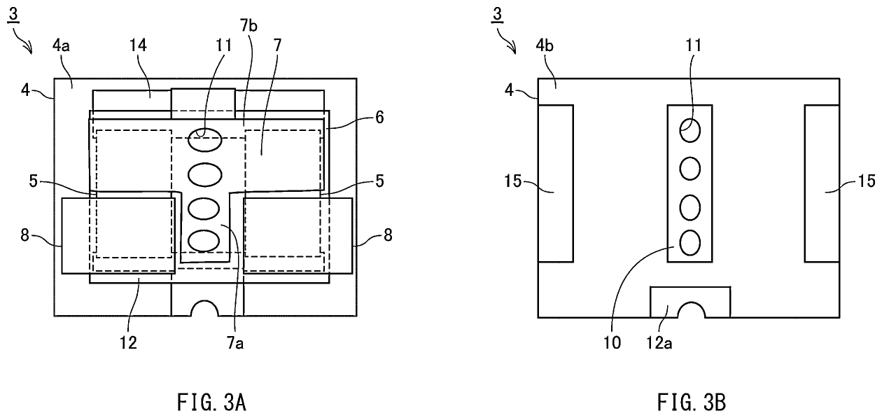

As shown in FIGS. 1, 2, and 3, a protecting device 1 according to the present invention includes a fuse element 2 and a blowing member 3 that blows the fuse element 2. FIG. 1 is a plan view of the protecting device 1, FIG. 2 is a cross-sectional view of the protecting device 1 taken along line D-D′ shown in FIG. 1, and FIG. 3 shows the blowing member 3, in which FIG. 3A is a plan view of the front surface 4a of the insulating substrate 4, and FIG. 3B is a bottom view of the back surface 4b of the insulating substrate 4.

The blowing member 3 includes an insulating substrate 4, a heat generator 5 formed on the front surface 4a side of the insulating substrate 4, an insulating layer 6 covering the heat generator 5, a heat-generator lead-out electrode 7 connected to the heat generator 5 and superimposed with the heat generator 5 via the insulating layer 6, and a heat-dissipating portion 8 formed on the front surface 4a side of the insulating substrate 4 at least in an area superimposed with the heat generator 5 and is electrically independent from the heat-generator lead-out electrode 7.

On the back surface 4b that is the reverse side of the front surface 4a of the insulating substrate 4, a holding electrode 10 is formed to hold the melted conductor 2a of the fuse element 2 when the fuse element 2 melts, and the heat-generator lead-out electrode 7 and the holding electrode 10 are connected by a through-hole 11 penetrating the insulating substrate 4 to the heat-generator lead-out electrode 7.

The fuse element 2 is connected to the holding electrode 10 by a bonding material such as connecting solder 9. The fuse element 2 is also connected to the first and second electrode terminals 21, 22, both ends of which are connected to an external circuit, by a bonding material such as the connecting solder 9.

According to this protecting device 1, since the heat-dissipating portion 8 is formed at least in an area superimposed with the heat generator 5, uneven heat distribution caused by the heating of the heat generator 5 is reduced on the insulating substrate 4. Therefore, damage to the insulating substrate 4 and the heat generator 5 due to stress caused by uneven heat distribution can be prevented, and the fuse element 2 can be blown safely and quickly even when high voltage is applied to the heat generator 5.

The following is a detailed description of each configuration of the blowing member 3 of the protecting device 1 and the fuse element 2.

### Blowing Member

### Insulating Substrate

The blowing member 3 includes the insulating substrate 4. The insulating substrate 4 is formed of an insulating material such as alumina, glass ceramics, mullite, or zirconia. Alternatively, the insulating substrate 4 may be made of other materials used for printed wiring boards, such as glass epoxy and phenolic substrates. The heat generator 5 is formed on the front surface 4a of the insulating substrate 4.

In the present invention, the side on which the heat generator 5 is formed on the insulating substrate 4 is referred to as the front surface 4a, as shown in FIG. 3A, and the reverse side of the front surface 4a is referred to as the back surface 4b, as shown in FIG. 3B. The insulating substrate 4 has a through-hole 11 that connects the heat-generator lead-out electrode 7 formed on the front surface 4a and the holding electrode 10 formed on the back surface 4b, as described below.

### Heat Generator

The heat generator 5 is an electrically conductive member having a relatively high resistance value and generating heat when energized, and is made of, e.g., nichrome, W, Mo, Ru, or a material containing these materials. The heat generator 5 can be formed by mixing the powder of these alloys, the compositions, or compounds with a resin binder or the like to form a paste, forming a pattern on the insulating substrate 4 using screen printing technology, and then baking the paste.

In the protecting device 1 shown in FIG. 2, two heat generators 5 are formed in parallel on the front surface 4a of the insulating substrate 4. Each heat generator 5 is connected to a heat-generator feeding electrode 12 at one end and to a heat-generator electrode 14 at the other end. The heat-generator feeding electrode 12 is connected to one end of the heat generator 5 and serves as a terminal for supplying power to the heat generator 5, and is continuous with the external connection electrode 12a formed on the back surface 4b of the insulating substrate 4 via castration. Each heat generator 5 is covered by the insulating layer 6, and the heat-generator lead-out electrode 7 formed on the insulating layer 6 is superimposed therewith.

The external connection electrode 12a is connected to the third electrode terminal 23, which is connected to an external circuit, by means of a bonding material such as the connecting solder 9, thereby connecting to a power source provided in the external circuit and enabling the power supply to the heat generator 5. The heat-generator electrode 14 is connected to the heat-generator lead-out electrode 7 described below.

The heat-generator feeding electrode 12 and the heat-generator electrode 14 are formed by conductive patterns such as Ag and Cu, respectively. On the surface of the heat-generator feeding electrode 12 and the heat-generator electrode 14, a film such as Ni/Au plating, Ni/Pd plating, Ni/Pd/Au plating, or the like is preferably coated by a known method such as plating. This allows the protecting device 1 to prevent oxidation of the heat-generator feeding electrode 12 and the heat-generator electrode 14, and to prevent fluctuations in ratings due to increased conduction resistance.

The heat-generator feeding electrode 12 is preferably provided with a regulatory wall (not shown) to prevent the connecting solder connecting the external connection electrode 12a to the third electrode terminal 23 and melted during reflow mounting or the like from crawling up onto the heat-generator feeding electrode 12 via the castellation and wetly spreading over the heat-generator feeding electrode 12. The regulatory wall can be formed using an insulating material that does not have wettability to solder, such as glass, solder resist, or insulating adhesive, and can be formed by printing on the heat-generator feeding electrode 12. The regulatory wall prevents the melted solder 9 for connection from wetly spreading to the heat-generator feeding electrode 12, thereby maintaining the connectivity between the protecting device 1 and the external circuit board.

The insulating layer 6 is provided to protect and insulate the heat generator 5 and is made of, e.g., a glass layer. The insulating layer 6 is thinly formed, e.g., 10 to 40 μm in thickness. The insulating layer 6 may also be formed between the front surface 4a of the insulating substrate 4 and the heat generator 5.

### Heat-Generator Lead-Out Electrode

As with the heat-generator feeding electrode 12 and the heat-generator electrode 14, the heat-generator lead-out electrode 7 is formed by a conductive pattern of Ag, Cu, or the like. On the surface of the heat-generator lead-out electrode 7, a coating such as Ni/Au plating, Ni/Pd plating, Ni/Pd/Au plating, or the like is preferably coated by a known method such as plating.

The heat-generator lead-out electrode 7 is connected to the heat-generator electrode 14 at one end, is formed on the insulating layer 6, and is superimposed with the heat generator 5 via the insulating layer 6. The heat-generator lead-out electrode 7 includes a tip portion 7a extending between the two heat generators 5 in an area where the heat generators 5 are not formed, and a base portion 7b superimposed with the two heat generators 5 and connected to the heat-generator electrode 14. With respect to the width direction orthogonal to the current flow direction of the heat generators 5, the base portion 7b of the heat-generator lead-out electrode 7 is the wide portion formed superimposed with the two heat generators 5, and the tip portion 7a is the narrow portion protruding from the base portion 7b and extending into the area between the two heat generators 5.

The heat-generator lead-out electrode 7 includes a through-hole 11 and is thus electrically and thermally connected to the holding electrode 10 formed on the back surface 4b of the insulating substrate 4. As a result, heat from the heat generator 5 is transferred to the fuse element 2 through the heat-generator lead-out electrode 7, the through-hole 11, and the holding electrode 10, causing the fuse element 2 to melt. The melted conductor 2a of the fuse element 2 is sucked into the through-hole 11 and held on the heat-generator lead-out electrode 7.

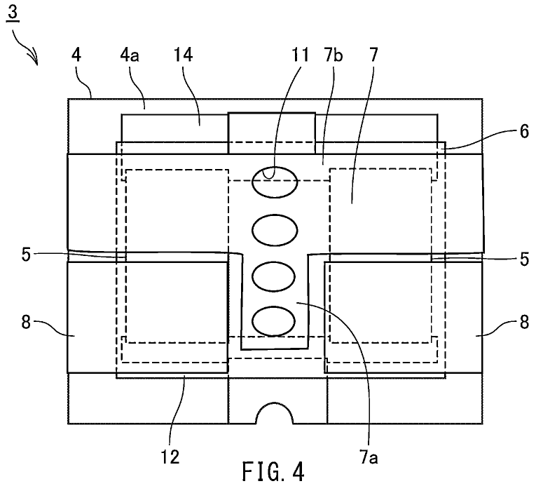

As shown in FIG. 4, the base portion 7b of the heat-generator lead-out electrode 7 may be formed beyond the insulating layer 6 to both edges of the insulating substrate 4. The larger the area of the heat-generator lead-out electrode 7, the more heat from the heat generator 5 is diffused onto the insulating substrate 4, making it easier to eliminate uneven heat distribution on the insulating substrate 4.

### Heat-Dissipating Portion

As shown in FIG. 3A, a heat-dissipating portion 8, which is electrically independent from the heat-generator lead-out electrode 7, is formed on the front surface 4a side of the insulating substrate 4, at least in an area superimposed with the heat generator 5. The heat-dissipating portion 8 absorbs heat generated by the heat generator 5 and is provided to reduce uneven heat distribution on the insulating substrate 4.

Forming the heat-dissipating portion 8 can suppress damage to the insulating substrate 4 and the heat generator 5 (thermal shock cracking) caused by heat concentration when the heat generator 5 generates heat. That is, in the blowing member 3, heat from the heat generator 5 is transferred to the insulating substrate 4, the heat-generator lead-out electrode 7, and the heat-dissipating portion 8. If the heat-dissipating portion 8 is not formed, heat from the heat generator 5 is absorbed by the insulating substrate 4 and the heat-generator lead-out electrode 7 in the area where the heat-generator lead-out electrode 7 is formed, but in the area where the heat-generator lead-out electrode 7 is not formed, the heat is concentrated on the insulating substrate 4 side. This results in uneven heat distribution on the insulating substrate 4, and cracks can occur due to thermal shock in areas where heat is concentrated. The heat generator 5 itself can also crack due to local overheating. On the contrary, by forming a heat-dissipating portion 8, heat is absorbed in the same manner as the heat-generator lead-out electrode 7, which reduces the uneven heat distribution on the insulating substrate 4 and prevents cracks from occurring. In addition, the heat generator 5 itself is not locally overheated, preventing cracks.

This prevents damage to the insulating substrate 4 and the heat generator 5 due to stress caused by uneven heat distribution, allowing the fuse element 2 to melt safely and quickly even when high voltage is applied to the heat generator 5.

The heat-dissipating portion 8 can be made of any material that can absorb the heat generated by the heat generator 5, and can be formed using conductive materials such as Ag, Cu, or their alloys, for example. The heat-dissipating portion 8 can be formed by screen printing or other known methods.

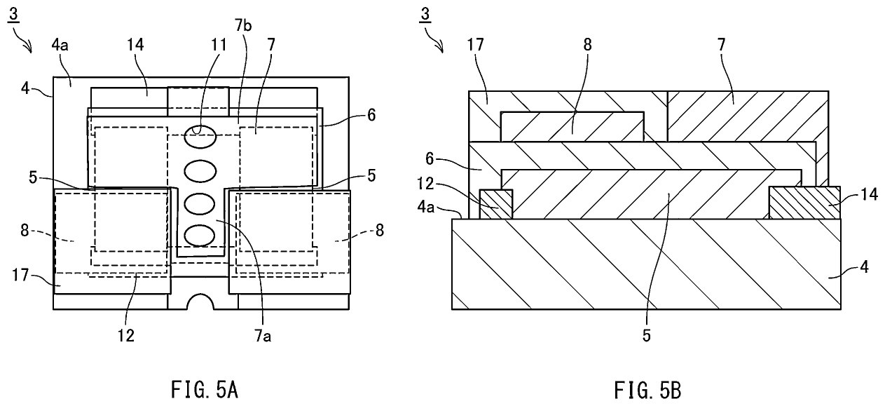

As shown in FIG. 5, an insulating coating layer 17 may be formed to coat and insulate the heat-dissipating portion 8. Forming the insulating coating layer 17 protects the heat-dissipating portion 8 and prevents a short circuit between the heat-dissipating portion 8 and the heat-generator lead-out electrode 7 or the like when the heat-dissipating portion 8 is formed of conductive material, thereby ensuring the electrical independence of the heat-dissipating portion 8. The insulating coating layer 17 is made of, e.g., a glass layer and can be formed by screen printing glass paste.

The heat-dissipating portion 8 is formed in the area of the heat generator 5 where the heat-generator lead-out electrode 7 is not provided, and is superimposed with the heat generator 5 via the insulating layer 6. The heat-dissipating portion 8 may be formed only in the area superimposed with the heat generator 5, or it may be formed from the area superimposed with the heat generator 5 to the area where the heat generator 5 is not formed on the insulating substrate 4. It may also be formed over the surface and sides of the insulating layer 6 to cover the surface and sides of the heat generator 5, as shown in FIG. 2. This increases the heat-absorbing capacity and efficiently absorbs heat.

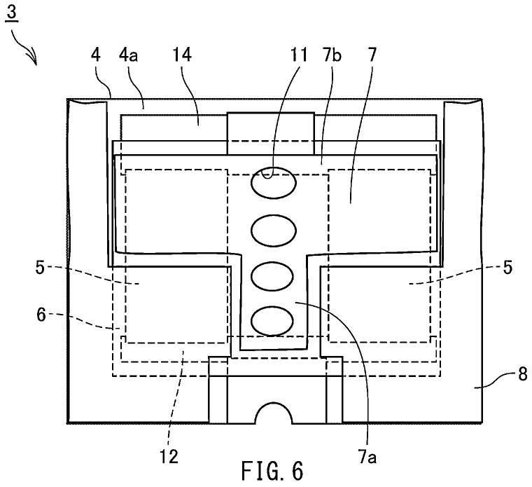

The heat-dissipating portion 8 may be formed on the front surface 4a of the insulating substrate 4 in an area where various electrodes such as the heat-generator lead-out electrode 7, the heat-generator feeding electrode 12, and the heat-generator electrode 14 are not formed, as shown in FIG. 6. The larger the area of the heat-dissipating portion 8 as much as possible, the more the uneven heat distribution on the insulating substrate 4 is eliminated and the more damage to the insulating substrate 4 and the heat generator 5 can be prevented even when high voltage is applied. It is preferable for the blowing member 3 to form the heat generator 5 and the heat-dissipating portion 8 symmetrically on the insulating substrate 4 in plan view to eliminate unbalanced heat distribution on the insulating substrate 4.

The heat-dissipating portion 8 is not connected to the heat-generator lead-out electrode 7 or other electrodes and is electrically independent. As a result, the heat-dissipating portion 8 is not at the same potential as the heat-generator lead-out electrode 7, and sparks (dielectric breakdown) between electrodes having different potentials can be suppressed. That is, since a potential difference occurs between the tip portion 7a of the heat-generator lead-out electrode 7 and the heat-generator feeding electrode 12, which are formed in close proximity, a spark may occur when a high potential is applied to the heat generator 5. The shock from the spark may damage the heat-generator lead-out electrode 7 and the insulating substrate 4, preventing the fuse element 2 from melting quickly and causing the heat generator 5 to stop generating heat. However, forming the electrically independent heat-dissipating portion 8 between the two electrodes 12 and 7a prevents sparks from occurring between the tip portion 7a of the heat-generator lead-out electrode 7 and the heat-generator feeding electrode 12.

### Holding Electrode

On the back surface 4b of the insulating substrate 4, a holding electrode 10, an auxiliary electrode 15, and an external connection electrode 12a are formed and connected to the fuse element 2 by a connecting material such as the connecting solder 9. The holding electrode 10 is formed at a position opposite to the heat-generator lead-out electrode 7 formed in the center of the front surface 4a via the insulating substrate 4. The holding electrode 10 is continuous with the heat-generator lead-out electrode 7 via a through-hole 11 that penetrates from the surface of the holding electrode 10 to the heat-generator lead-out electrode 7. As a result, the melted conductor 2a of the melted fuse element 2 is sucked to the heat-generator lead-out electrode 7 through the through-hole 11.

The auxiliary electrode 15, together with the holding electrode 10, is connected to the fuse element 2 and holds the melted conductor 2a. A pair of the auxiliary electrodes 15 formed on both edges of the insulating substrate 4, thereby sandwiching the holding electrode 10.

The holding electrode 10 and the auxiliary electrode 15 can be formed by screen printing or other known methods using known electrode materials such as Ag, Cu, or alloy materials mainly composed of Ag or Cu.

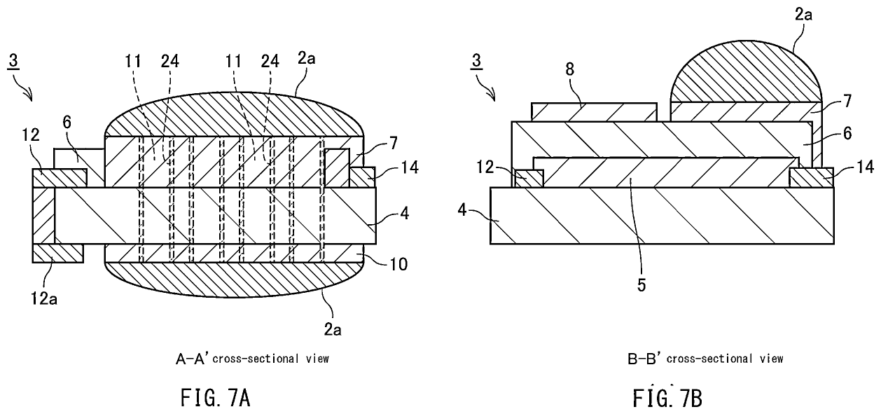

The through-hole 11 sucks the melted conductor 2a of the fuse element 2 by capillary phenomenon when the fuse element 2 melts, thereby reducing the volume of the melted conductor 2a held on the holding electrode 10. As a result, even when the fuse element 2a becomes larger due to the higher rating and higher capacity of the protecting device 1 and the amount of melting increases, a large volume of the melted conductor 2a can be held by the holding electrode 10, the heat-generator lead-out electrode 7, and the auxiliary electrode 15 as shown in FIG. 7 to securely blow the fuse element 2a.

The through-hole 11 is formed in the area of the insulating substrate 4 where the heat generator 5 is not formed. In the blowing member 3 shown in FIG. 3, the through-hole 11 is formed in the area between the parallel heat generators 5.

The through-hole 11 has a conductive layer 24 formed on the inner surface. The conductive layer 24 is continuous with the holding electrode 10 and the heat-generator lead-out electrode 7. As a result, the holding electrode 10 and the heat-generator lead-out electrode 7 are electrically connected through the conductive layer 24. In addition, the conductive layer 24 allows the heat generated by the heat generator 5 to be quickly transferred to the fuse element 2 via the heat-generator lead-out electrode 7 and the holding electrode 10.

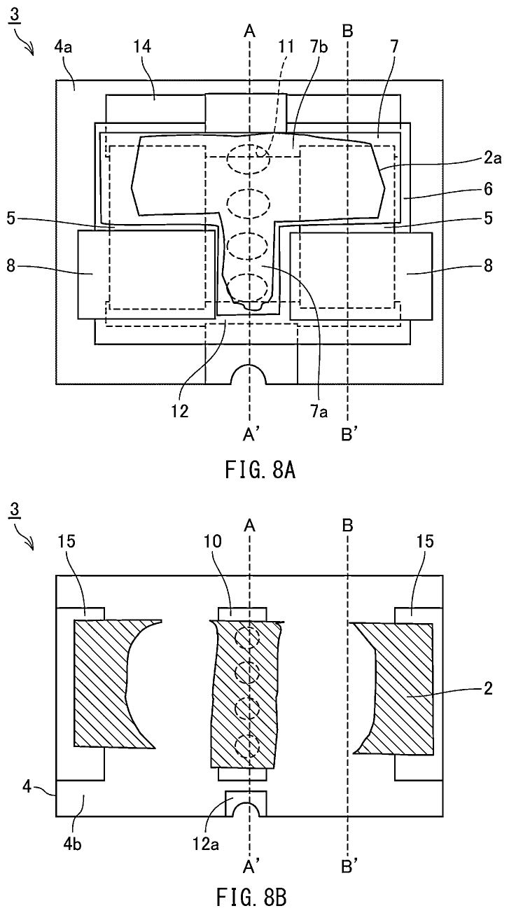

Since the holding electrode 10 supports the fuse element 2 and the melted conductor 2a agglomerates during the blowing, the continuity between the holding electrode 10 and the conductive layer 24 makes it easier to guide the melted conductor 2a into the through-hole 11. In addition, the melted conductor 2a is wetly spread, and held by the heat-generator lead-out electrode 7, which is continuous with the conductive layer 24 (see FIGS. 7 and 8). Therefore, more amount of the melted conductor 2a can be sucked and held in the through-hole 11 and the heat-generator lead-out electrode 7, reducing the volume of the melted conductor 2a held by the holding electrode 10 and the auxiliary electrode 15, thereby ensuring the blowout.

The conductive layer 24 is formed, e.g., by copper, silver, gold, iron, nickel, palladium, lead, or tin, or an alloy mainly composed of any of these, and can be formed by electrolytic plating or printing conductive paste on the inner surface of the through-hole 11 or other known methods. The conductive layer 24 may also be formed by inserting a plurality of metal wires or an aggregate of conductive ribbons into the through-hole 11.

The blowing member 3 may be provided with a plurality of the through-holes 11. This increases the heat transfer path of the heat generator 5 to more quickly transfer heat to the fuse element 2, increases the path for sucking the melted conductor 2a of the fuse element 2, and reduces the volume of the melted conductor 2a at the melting portion by quickly sucking more amount of the melted conductor 2a.

### Formation Steps of Blowing Member

The blowing member 3 is prepared by forming the heat-generator feeding electrode 12 and the heat-generator electrode 14 on the front surface 4a of the insulating substrate 4 by screen printing or other known methods, forming the heat generator 5, and then laminating the insulating layer 6. Next, the heat-dissipating portion 8 and the heat-generator lead-out electrode 7 are formed. The back surface 4b of the insulating substrate 4 is also formed using screen printing or other known methods to form the holding electrode 10, the external connection electrode 12a, and the auxiliary electrode 15. Thereafter, the through-holes 11 are formed by drilling or the like, and the conductive layer 24 is formed by plating or the like to complete the blowing member 3. The blowing member 3, the holding electrode 10, and the auxiliary electrode 15 are connected to the fuse element 2 by the connecting solder 9. The fuse element 2 to which the blowing member 3 is connected is connected, by the connecting solder 9, to the first and second electrode terminals 21, 22 supported on a side edge portion 30a of a lower case 30. The external connection electrode 12a of the insulating substrate 4 is connected, by the connecting solder 9, to the third electrode terminal 23 supported on the side edge portion 30a of the lower case 30.

### Fuse Element Sandwiching Configuration

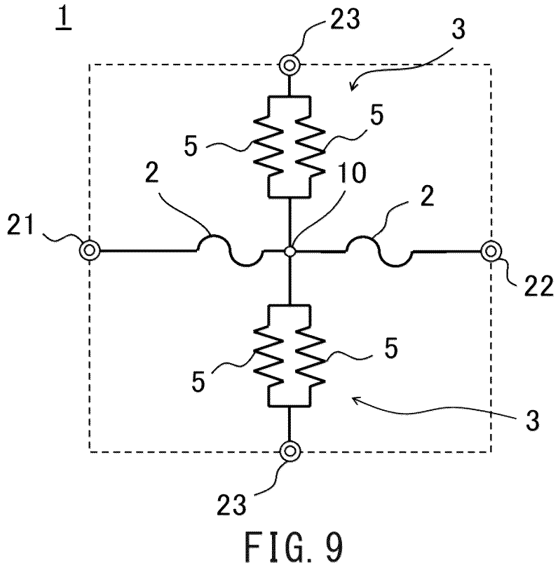

In the protecting device 1 shown in FIG. 2, the blowing members 3 are connected to one side of the fuse element 2 and to the other side opposite to the one side, respectively, whereby the fuse element 2 is sandwiched between multiple blowing members 3. FIG. 9 is a circuit diagram of the protecting device 1. In each of the blowing members 3 connected to one side and the other side of the fuse element 2, one end of the heat generator 5 is respectively connected to the fuse element 2 via the heat-generator lead-out electrode 7 and the holding electrode 10 formed on each of the insulating substrates 4. In addition, in each of the blowing members 3, the heat-generator feeding electrode 12 connected to the other end of the heat generator 5 is respectively connected to the third electrode terminal 23 via a connecting material such as the connecting solder 9, thereby being connected to a power source for heating the heat generator 5 provided in an external circuit via the third electrode terminal 23.

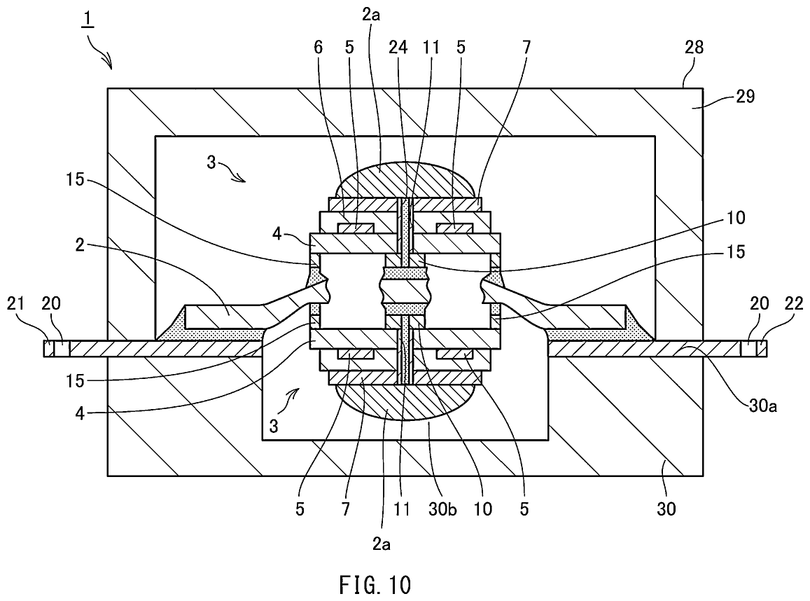

As shown in FIG. 10, in the protecting device 1, when the fuse element 2 is blown by the heat generated by the heat generator 5, the heat generators 5 of each blowing member 3, 3 connected to both sides of the fuse element 2 generate heat and apply the heat to the fuse element 2 from both sides. Therefore, the protecting device 1 can quickly heat and blow the fuse element 2 even when the cross-sectional area of the fuse element 2 is increased to accommodate high current applications.

In addition, the protecting device 1 sucks the melted conductor 2a from both sides of the fuse element 2 into the respective through-holes 11 formed in each of the blowing members 3 and holds the melted conductor 2a with the heat-generator lead-out electrode 7. Therefore, even when a large amount of the melted conductor 2a is generated because the cross-sectional area of the fuse element 2 is increased to accommodate high current applications, the protecting device 1 is capable of reliably blowing the fuse element 2 by sucking the melted conductor 2a with the plurality of blowing members 3. In addition, the protecting device 1 can blow the fuse element 2 more quickly by sucking the melted conductor 2a with the plurality of blowing members 3.

The protecting device 1 can also quickly blow the fuse element 2 when the fuse element 2 employs a coated structure in which a low-melting-point metal constituting the inner layer is coated with a high-melting-point metal. Specifically, the fuse element 2 coated with high-melting-point metal takes time to heat up to the temperature at which the high-melting-point metal of the outer layer melts, even when the heat generator 5 generates heat. Here, by providing the plurality of blowing members 3 in the protecting device 1 and heating each heat generator 5 simultaneously, the high-melting-point metal of the outer layer can be quickly heated to the melting temperature. Therefore, according to the protecting device 1, the thickness of the high-melting-point metal layer that constitutes the outer layer can be made thicker, and the rapid blowout property can be maintained while achieving a higher rating.

In addition, in the protecting device 1, it is preferable that a pair of blowing members 3, 3 connected to the fuse element 2 face each other, as shown in FIG. 2. This allows the protecting device 1 to simultaneously heat the same part of the fuse element 2 from both sides and suck the melted conductor 2a by the pair of blowing members 3,3, thereby heating to blow the fuse element 2 more quickly.

In addition, it is preferable for the protecting device 1 that the holding electrode 10 and the auxiliary electrode 15 formed on the respective insulating substrates 4 of the pair of blowing members 3, 3 face each other through the fuse element 2. This symmetrical connection of the pair of blowing members 3, 3 suppresses unbalance in the load applied by the blowing member 3 to the fuse element 2 during reflow mounting and heating of the fuse element 2 or the like and improves the resistance to the deformation of the fuse element 2 and misalignment of the blowing member 3 or the like.

It is preferable to form the heat generator 5 on both sides of the through-hole 11 to heat the holding electrode 10 and the heat-generator lead-out electrode 7 and to aggregate and suck more of the melted conductor 2a.

### Fuse Element

The fuse element 2 is mounted between the first and second electrode terminals 21, 22 and melts due to heat generation caused by the heat generator 5 being energized or self-heating (Joule heat) caused by a current exceeding its rated value flowing therethrough, thereby interrupting the current path between the first and second electrode terminals 21, 22.

The fuse element 2 can be any conductive material that melts due to heat generated by energizing the heat generator 5 or by an overcurrent condition, and for example, may be made of SnAgCu-based Pb-free solder as well as BiPbSn alloy, BiPb alloy, BiSn alloy, SnPb alloy, PbIn alloy, ZnAl alloy, InSn alloy, and PbAgSn alloys, among other materials.

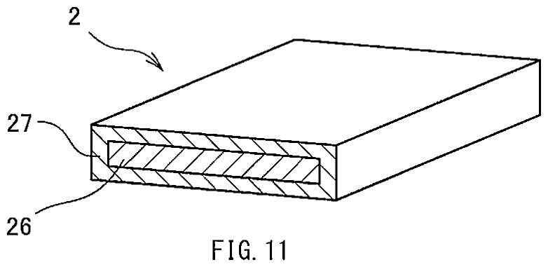

The fuse element 2 may have a structure having a high-melting-point metal and a low-melting-point metal. For example, as shown in FIG. 11, the fuse element 2 may have a laminated structure consisting of an inner layer and an outer layer and may include a low-melting-point metal layer 26 as the inner layer and a high-melting-point metal layer 27 as the outer layer laminated on the low-melting-point metal layer 26. The fuse element 2 is connected to the first and second electrode terminals 21, 22, the holding electrode 10, and the auxiliary electrode 15 via a bonding material such as the connecting solder 9.

The low-melting-point metal layer 26 is preferably a solder or Sn-based metal and is commonly referred to as “Pb-free solder”. The melting point of the low-melting-point metal layer 26 does not necessarily need to be higher than the temperature of the reflow oven and may melt at about 200° C. The high-melting-point metal layer 27 is a metal layer laminated on the surface of the low-melting-point metal layer 26, made of, e.g., Ag or Cu, or a metal mainly composed of one of these, and has a high melting point that does not melt even when the first and second electrode terminals 21, 22, the holding electrode 10, and the auxiliary electrode 15 are connected to the fuse element 2 by reflow.

The fuse element 2 can be formed by depositing a high-melting-point metal layer on a low-melting-point metal foil using plating technology, or by using other known lamination and film-formation technologies. The fuse element 2 may have a structure in which the entire surface of the low-melting-point metal layer 26 is covered by the high-melting-point metal layer 27 or may have a structure in which it is covered except for a pair of opposing sides. The fuse element 2 can be formed in various configurations, such as having the high-melting-point metal layer 27 as the inner layer and the low-melting-point metal layer 26 as the outer layer, having a multilayer structure with three or more alternating layers of low-melting-point metal and high-melting-point metal layers, or having an opening in part of the outer layer to expose a part of the inner layer.

By laminating the high-melting-point metal layer 27 as the outer layer on the low-melting-point metal layer 26 as the inner layer, the fuse element 2 can maintain the shape as a fuse element 2 even when the reflow temperature exceeds the melting temperature of the low-melting-point metal layer 26 and will not be blown. Therefore, the first and second electrode terminals 21, 22, the holding electrode 10, and the auxiliary electrode 15 can be efficiently connected to the fuse element 2 by reflow, and it is possible to prevent changes in blowout properties, which might otherwise cause a problem in which the fuse element 2 might be deformed to locally increase or decrease the resistance value so that it cannot be blown at a predetermined temperature or will be blown below a predetermined temperature. Therefore, the protecting device 1 can quickly blow the fuse element 2 by a predetermined overcurrent or heat generation of the heat generator 5.

In addition, the fuse element 2 does not melt due to self-heating as long as the predetermined rated current flows. When a current exceeding the rated value flows, the fuse element 2 melts due to self-heating (Joule heat) and interrupts the current path between the first and second electrode terminals 21, 22.

Furthermore, when the heat generator 5 is energized and generates heat, the fuse element 2 is blown to interrupt the current path between the first and second electrode terminals 21, 22. At this time, in the fuse element 2, the melted low-melting-point metal layer 26 erodes the high-melting-point metal layer 27 (solder erosion), whereby the high-melting-point metal layer 27 melts at a temperature lower than the melting temperature thereof. Thus, the fuse element 2 can be blown in a short time by utilizing the erosion action on the high-melting-point metal layer 27 by the low-melting-point metal layer 26. In addition, since the fuse element 2 is separated by the physical drawing action of the melted conductor 2a by the holding electrode 10 and the auxiliary electrode 15, the fuse element 2 can quickly and reliably interrupt the current path between the first and second electrode terminals 21, 22 (FIGS. 8 and 10).

The fuse element 2 may be made so that the volume of the low-melting-point metal layer 26 is larger than the volume of the high-melting-point metal layer 27. The fuse element 2 is heated by self-heating due to overcurrent or by heat generated by the heat generator 5, and the low-melting-point metal melts and erodes the high-melting-point metal, which can quickly melt and blow the fuse element 2. Therefore, by forming the volume of the low-melting-point metal layer 26 larger than that of the high-melting-point metal layer 27, the fuse element 2 can promote this erosion action and quickly interrupt the path between the first and second electrode terminals 21, 22.

Further, the fuse element 2, which is composed of the high-melting-point metal layer 27 laminated on the low-melting-point metal layer 26 serving as the inner layer can significantly reduce the melting temperature compared to conventional chip fuses and other fuses made of high-melting-point metals. Therefore, the fuse element 2 can be formed to have a larger cross-sectional area and a much higher current rating compared to chip fuses of the same size. In addition, the fuse element 2 can be made smaller and thinner than conventional chip fuses having the same current rating and is excellent in the rapid blowout property.

In addition, the fuse element 2 can improve resistance to a surge (pulse resistance) which would occur when an abnormally high voltage is momentarily applied to the electric system incorporating the protecting device 1. For example, the fuse element 2 must not be blown in the case of a 100 A current flowing for a few milliseconds. In this respect, since a large current flowing for an extremely short time flows through the surface layer of the conductor (skin effect), and the fuse element 2 is provided with a high-melting-point metal layer 27 such as Ag plating with low resistance as an outer layer, a current caused by a surge can easily flow to prevent blowout due to self-heating. Therefore, the fuse element 2 can significantly improve serge tolerance compared to fuses made of conventional solder alloys.

The fuse element 2 may be coated with flux (not shown) to prevent oxidation and to improve wettability at the time of blowout.

The first and second electrode terminals 21, 22, which are connected to the ends of the fuse element 2, are conductive terminals and are arranged to extend from the inside to the outside of the case 28 of the protecting device 1. The first and second electrode terminals 21, 22 provided with screw holes 20 in the tip portions that are led out of the case 28 and can be connected to connection electrodes provided in an external circuit by screwing or other means.

The third electrode terminal 23, which is connected to the external connection electrode 12a connected to the heat-generator feeding electrode 12 described above, is similarly arranged to extend from the inside to the outside of the case 28 of the protecting device 1 and is provided with screw holes 20 at the tip that is led out of the case 28.

### Case

The inside of the protecting device 1 is protected by the fuse element 2 and the blowing member 3 covered by the case 28. The case 28 can be formed from an insulating material such as various engineering plastics, thermoplastics, ceramics, and glass epoxy substrates, among others. The case 28 houses the fuse element 2 and the blowing member 3, and has sufficient internal space for the melted conductor 2a to expand spherically upon melting of the fuse element 2 and aggregate on the heat-generator lead-out electrode 7.

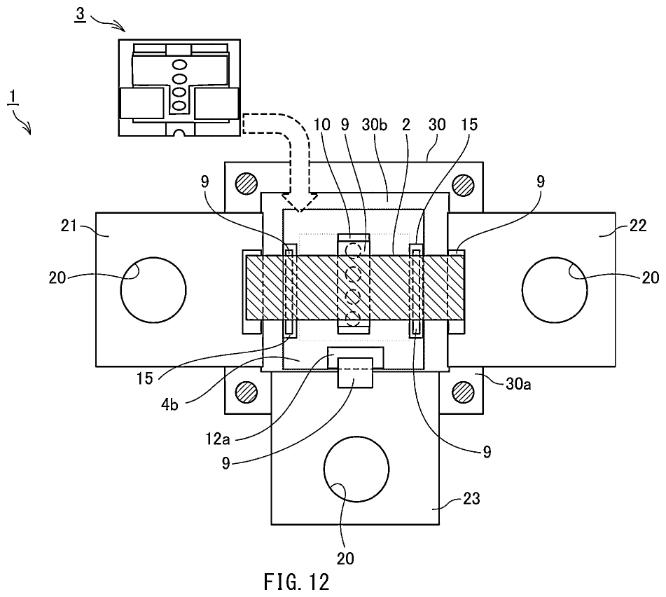

As shown in FIGS. 2 and 12, the case 28 is formed by combining an upper case 29 and a lower case 30. The lower case 30 is formed in a substantially rectangular shape and includes a side edge portion 30a supporting the first to third electrode terminals 21 to 23 and a hollow portion 30b to accommodate the blowing member 3 connected to the lower side of the fuse element 2.

The side edge portion 30a supports the first to third electrode terminals 21 to 23 arranged to extend from the inside to the outside of the case 28. The hollow portion 30b accommodates the blowing member 3 connected to the lower side of the fuse element 2 and has an internal space that allows the melted conductor 2a to wetly spread and aggregate on the heat-generator lead-out electrode 7.

The upper case 29 is formed in a substantially rectangular shape as with the lower case 30, and abut on and joined with the lower case 30 to cover the fuse element 2 and the blowing member 3 connected to the upper side of the fuse element 2. The upper case 29 has an internal space that allows the melted conductor 2a to wetly spread and aggregate on the heat-generator lead-out electrode 7.

### Circuit Configuration Example

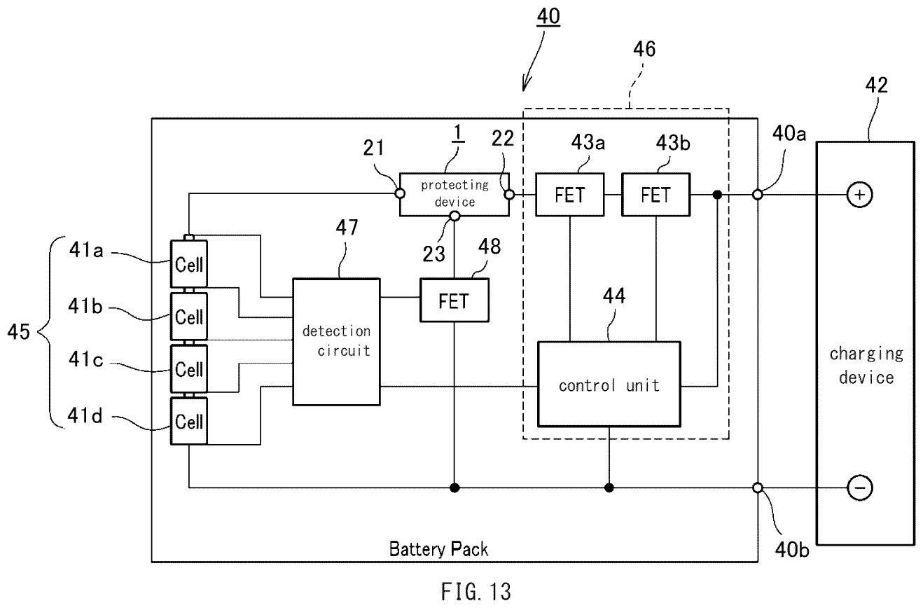

As shown in FIG. 13, the protecting device 1 is used, e.g., in a circuit in a battery pack 40 of a lithium-ion secondary battery. The battery pack 40 includes a battery stack 45 having, e.g., a total of four lithium-ion secondary battery cells 41a to 41d.

The battery pack 40 includes: a battery stack 45; a charge/discharge control circuit 46 that controls the charge/discharge of the battery stack 45; the protecting device 1 according to the present invention that interrupts a charging/discharging path when the state of the battery stack 45 is abnormal: a detection circuit 47 that detects the voltage of each battery cell 41a to 41d; and a current control element 48 that serves as a switch element to control the operation of the protecting device 1 in accordance with the detection results of the detection circuit 47.

In the battery stack 45, the battery cells 41a to 41d requiring control for protection from over-charging and over-discharging states are connected in series and are detachably connected to the charging device 42 via a positive electrode terminal 40a and a negative electrode terminal 40b of the battery pack 40 so as to apply charging voltage from the charging device 42. By connecting the positive electrode terminal 40a and the negative electrode terminal 40b to a battery-driven electronic device, the battery pack 40 charged by the charging device 42 can drive this electronic device.

The charge/discharge control circuit 46 includes two current control elements 43a, 43b connected in series in the current path between the battery stack 45 and the charging device 42, and a control unit 44 that controls the operation of these current control elements 43a, 43b. The current control elements 43a, 43b are formed of, e.g., field effect transistors (hereinafter referred to as FETs) and the control unit 44 controls the gate voltage to switch the current path of the battery stack 45 between a conduction state and interrupted state in the charging and/or discharging direction. The control unit 44 is powered by the charging device 42 and controls the operation of the current control elements 43a, 43b according to the detection results by the detection circuit 47 to interrupt the current path when the battery stack 45 is over-discharged or over-charged.

The protecting device 1 is connected, e.g., in the charge/discharge current path between the battery stack 45 and the charge/discharge control circuit 46, and the operation thereof is controlled by the current control element 48.

The detection circuit 47 is connected to each of the battery cells 41a to 41d so as to detect the voltage values of each of the battery cells 41a to 41d and supplies each of the voltage values to the control unit 44 of the charge/discharge control circuit 46. Furthermore, the detection circuit 47 outputs a control signal to control the current control element 48 when an over-charging voltage or over-discharging voltage is detected in any one of the battery cells 41a to 41d.

When the detection signal output from the detection circuit 47 indicates a voltage exceeding a predetermined threshold value corresponding to the over-discharging or over-charging state of the battery cells 41a to 41d, the current control element 48 such as an FET, for example, activates the protecting device 1 to interrupt the charging/discharging current path of the battery stack 45 without the switching operation of the current control elements 43a, 43b.

The protecting device 1 according to the present invention, which is used in the battery pack 40 having the configuration, has the circuit configuration shown in FIG. 9. That is, in the protecting device 1, the first electrode terminal 21 is connected to the battery stack 45 side and the second electrode terminal 22 is connected to the positive electrode terminal 40a side, whereby the fuse element 2 is connected in series on the charging/discharging path of the battery stack 45. Furthermore, in the protecting device 1, the heat generator 5 is connected to the current control element 48 via the heat-generator feeding electrode 12 and the third electrode terminal 23, and the heat generator 5 is connected to the open end of the battery stack 45. As a result, one end of the heat generator 5 is connected to the fuse element 2 and one open end of the battery stack 45 via the heat-generator lead-out electrode 7 and the holding electrode 10, and the other end is connected to the other open end of the current control element 48 and the battery stack 45 via the third electrode terminal 23. This forms a power supply path to the heat generator 5 the conduction of which is controlled by the current control element 48.

### Operation of Protecting Device

When the protecting device 1 is mounted on an external circuit board, the heat generator 5 is connected to the current control element 48 and other elements formed in the external circuit via the third electrode terminal 23, and energization and heat generation of the heat generator 5 are regulated under normal conditions. Upon detecting an abnormal voltage in any of the battery cells 41a to 41d, the detection circuit 47 outputs an interruption signal to the current control element 48. The current control element 48 then controls the current to energize the heat generator 5. The heat generator 5 begins to generate heat when current flows from the battery stack 45.

The heat of the heat generator 5 is transferred to the fuse element 2 through the heat-generator lead-out electrode 7, the through-hole 11, and the holding electrode 10, causing the fuse element 2 to melt. The melted conductor 2a aggregates on the holding electrode 10, the auxiliary electrode 15, and the heat-generator lead-out electrode 7, and the fuse element 2 is thus blown between the holding electrode 10 and the auxiliary electrode 15 (FIGS. 8 and 10).

The heat of the heat generator 5 is transferred from the insulating substrate 4 to the fuse element 2 via the holding electrode 10 and the auxiliary electrode 15. Furthermore, in the protecting device 1, by forming the fuse element 2 with a high-melting-point metal and a low-melting-point metal, the low-melting-point metal melts before the high-melting-point metal melts, and the fuse element 2 can be blown in a short time by utilizing the erosive action on the high-melting-point metal by the melted low-melting-point metal.

When the fuse element 2 is blown, the charging/discharging path of the battery stack 45 is interrupted between the first and second electrode terminals 21, 22. The heat generator 5 also stops generating heat because the blowout of the fuse element 2 also interrupts the power supply path to itself.

Here, the protecting device 1 includes the heat-dissipating portion 8 on the front surface 4a side of the insulating substrate 4, at least in an area superimposed with the heat generator 5, which is electrically independent from the heat-generator lead-out electrode 7. This allows the protecting device 1 to prevent damage to the insulating substrate 4 and the heat generator 5 due to stress caused by uneven heat distribution, and to blow the fuse element 2 safely and quickly even when a high voltage is applied to the heat generator 5. In addition, by forming a heat-dissipating portion 8, the protecting device 1 can safely and quickly interrupt the current path without sparking (discharge) even when a high voltage is applied to the heat-generator feeding electrode 12 from a battery stack 45 for high-current applications.

In addition, when a rate-exceeding overcurrent flows through the fuse element 2, the protecting device 1 can blow the fuse element 2 by self-heating to interrupt the charging/discharging path of the battery pack 40.

The protecting device 1 of the present invention is not limited to use in battery packs for lithium-ion secondary batteries, but can of course be applied to a variety of applications requiring the interruption of current paths by electrical signals.

### Protruding Portion

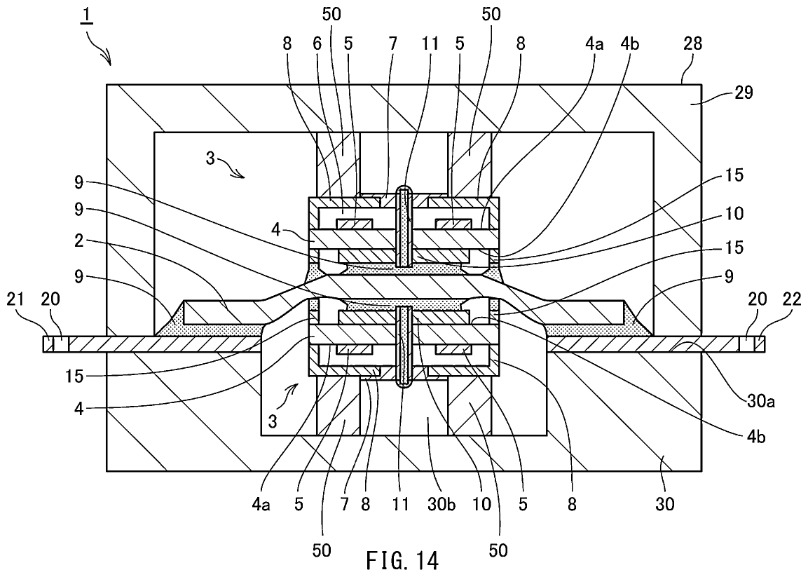

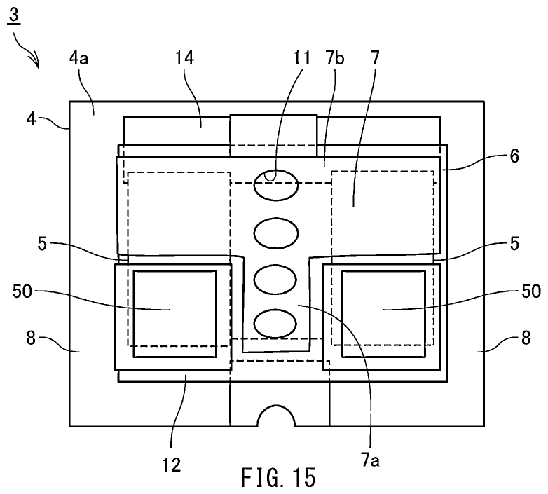

As shown in FIGS. 14 and 15, the protecting device 1 can have a protruding portion 50 formed in the case 28 that contacts the heat-dissipating portion 8 and absorbs heat. The protruding portion 50 is formed protruding from the upper case 29 and lower case 30, and its tip portion is in contact with the heat-dissipating portion 8. This allows heat absorbed by the heat-dissipating portion 8 to be diffused to the protruding portion 50 and case 28 for more efficient heat diffusion.

The protruding portion 50 is formed protruding from the top surface of the upper case 29 and the bottom surface of the hollow portion 30b of the lower case 30. The protruding portion 50 may be formed integrally with the upper case 29 and lower case 30, or it may be formed by a separate material from the upper case 29 and lower case 30 and connected by adhesion or other means.

The shape of the protruding portion 50 is not restricted and can be formed in any shape, e.g., a prismatic or cylindrical shape. The surface area may be increased by, e.g., forming uneven surfaces or grooves on the outer circumference of the protruding portion 50 to promote heat diffusion. In the case where the protruding portion 50 is made of a separate member from the case 28, the protruding portion 50 may be formed of a material with a higher thermal conductivity than the material of the case 28.

The tip portion of the protruding portion 50 is planar. This allows a large contact area with the heat-dissipating portion 8. In order to ensure surface contact between the tip of the protruding portion 50 and the heat-dissipating portion 8, a resin agent, resin sheet, or the like having excellent thermal conductivity and heat resistance may be interposed. This allows a wider contact area to be secured, thereby preventing a decrease in heat conduction efficiency to the protruding portion 50 even when the contact surfaces of the tip portion of the protruding portion 50 and the heat-dissipating portion 8 do not face each other in parallel or are rough surfaces.

The protruding portion 50 may be in contact only with the area superimposed with the heat generator 5 of the heat-dissipating portion 8, or it may be in contact with an area including the area superimposed with the heat generator 5 and an area other than the area superimposed with the heat generator 5.

### Heat-Dissipating Element

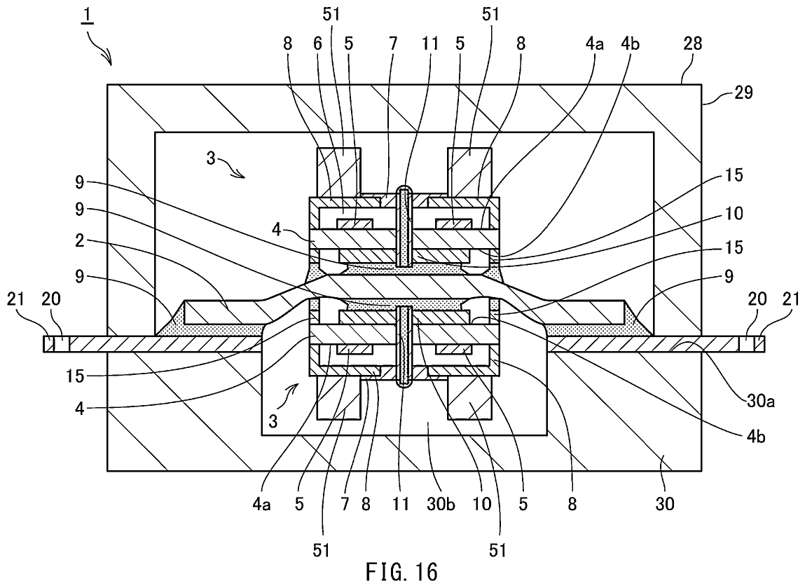

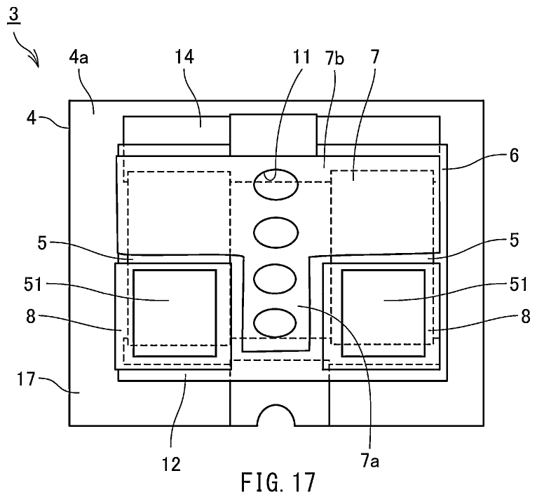

As shown in FIGS. 16 and 17, the protecting device 1 may be provided with a heat-dissipating element 51 that contacts the heat-dissipating portion 8 and absorbs and dissipates heat from the heat-dissipating portion 8. The heat-dissipating element 51 is in contact with the heat-dissipating portion 8 to absorb the heat of the heat-dissipating portion 8 and dissipate the heat into the space inside the case 28. By providing the heat-dissipating element 51, the protecting device 1 can efficiently diffuse heat.

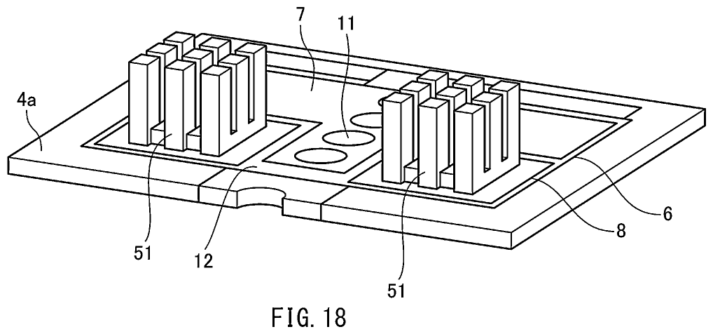

A material having excellent thermal conductivity, such as a high-melting-point metal, a resin material coated with a high-melting-point metal, or a heat sink (FIG. 18), can be suitably used for the heat-dissipating element 51. Although there are no restrictions on the size and shape of the heat-dissipating element 51, it is preferable that the element has a heat capacity that can sufficiently absorb heat from the heat-dissipating portion 8 and a surface area that can efficiently dissipate heat into the case 28. The heat-dissipating element 51 may have a surface area increased by forming uneven surfaces or grooves on the outer circumference in contact with the interior space of the case 28 to promote heat diffusion. At least the portion of the heat-dissipating element 51 in contact with the heat-dissipating portion 8 is preferably planer to ensure a large contact area with the heat-dissipating portion 8.

The heat-dissipating element 51 is connected to the heat-dissipating portion 8 by a connecting material such as a high-melting point solder or a thermally conductive sheet having tackiness. The reason for using solder or the like with a high melting point as the connecting material is that it must not be melted by the heat of the heat-dissipating portion 8. If the connecting material melts due to the heat of the heat-dissipating portion 8, the heat-dissipating element 51 may fall off or melt the heat-dissipating element such as high-melting-point metal.

The heat-dissipating element 51 may be in contact only with the area of the heat-dissipating portion 8 that is superimposed with the heat generator 5, or it may be in contact with an area that includes the area superimposed with the heat generator 5 and an area other than the area superimposed with the heat generator 5.

### Examples

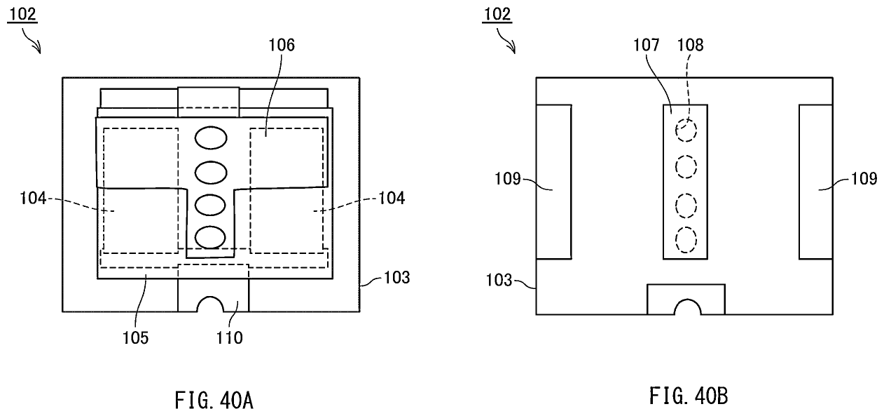

Examples of the protecting device 1 will be explained below. In this experiment, the protecting device shown in FIG. 2 was prepared as an example, and the protecting device without a heat-dissipating portion shown in FIG. 40 was prepared as a comparative example, and the presence or absence of damage to the heat generator or insulating substrate was determined when voltages of 50V, 60V, 80V, and 100V were applied to each. When no damage was observed on the heat generator or the insulating substrate, the evaluation was rated as “G” (good), and when damage was observed on the heat generator or the insulating substrate, the evaluation was rated as “B” (bad).

TABLE 1

applied voltage [V]

| | 50 | 60 | 80 | 100 |
|---|---|---|---|---|
| Example | G | G | G | G |
| Comparative example | G | B | B | B |

As shown in Table 1, in the example having the heat-dissipating portion, no damage was observed on the heat generator or the insulating substrate even when the applied voltage was increased, and the fuse element could be quickly blown. On the other hand, in the protecting device of the comparative example without the heat-dissipating portion, damage to the heat generator or the insulating substrate was observed at an applied voltage of 60V or higher. Therefore, in the comparative example, it took a long time to blow the fuse element, and there were cases where the heat generator was damaged and the fuse element could not be blown completely.

### Modification 1

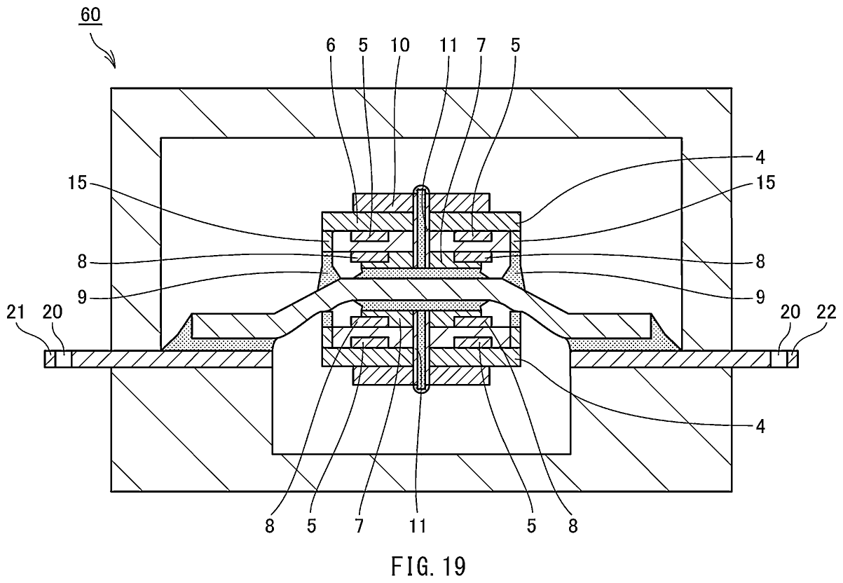

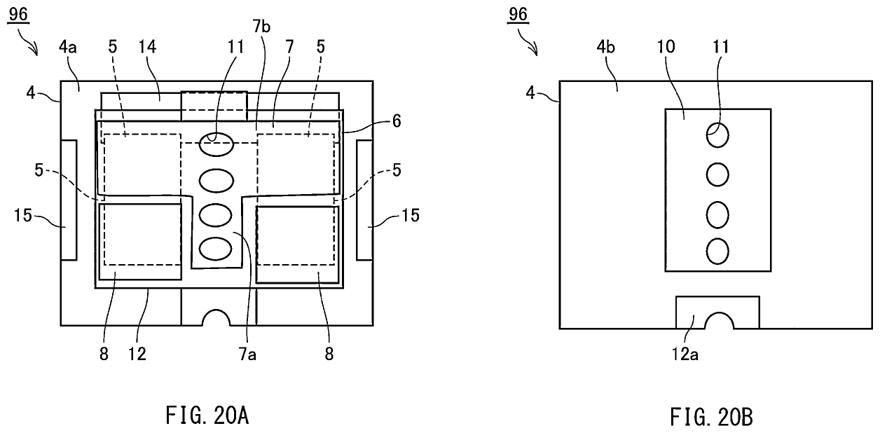

Next, a modification of a protecting device is described. In the following description, the same parts and materials as those of the above-described protecting device 1 are indicated with the same symbols and their details may be omitted. As shown in FIG. 19, the protecting device 60 according to the present technology has the heat-generator lead-out electrode 7 connected to the fuse element 2. As shown in FIGS. 19 and 20, in the protecting device 60, the auxiliary electrodes 15 are formed on both edges of the front surface 4a of the insulating substrate 4, sandwiching the heat-generator lead-out electrode 7 therebetween, and the auxiliary electrodes 15 and the heat-generator lead-out electrode 7 are connected to the fuse element 2 by the connecting solder 9. In other words, in the protecting device 60, the front surface 4a of the insulating substrate 4 on which the heat generator 5, the insulating layer 6, the heat-generator lead-out electrode 7, and the heat-dissipating portion 8 are formed is the surface in contact with the fuse element 2. When the heat generator 5 generates heat, the fuse element 2 is heated via the heat-generator lead-out electrode 7.

Furthermore, the insulating substrate 4 of the protecting device 60 includes the holding electrode 10 on the back surface 4b that is the reverse side of the front surface 4a in contact with the fuse element 2. The melted conductor 2a of the fuse element 2 is sucked and held on the side of the holding electrode 10, which is continuous with the heat-generator lead-out electrode 7 through the through-hole 11.

In the protecting device 60, as in the protecting device 1, the heat-dissipating portion 8 electrically independent from the heat-generator lead-out electrode 7 is formed on the front surface 4a side of the insulating substrate 4, at least in an area superimposed with the heat generator 5. Therefore, the protecting device 60 can prevent damage to the insulating substrate 4 and the heat generator 5 due to stress caused by uneven heat distribution, and can blow the fuse element 2 safely and quickly even when a high voltage is applied to the heat generator 5. In addition, by forming the heat-dissipating portion 8, the protecting device 60 is less likely to spark (discharge) even when a high voltage is applied to the heat-generator feeding electrode 12, and can safely and quickly interrupt the current path. Therefore, the protecting device 60 can be rated higher to accommodate high current applications.

In the protecting device 60 as well, the insulating coating layer 17 is preferably formed to coat and insulate the heat-dissipating portion 8. Forming the insulating coating layer 17 can prevent conduction with the fuse element 2 and the heat-generator lead-out electrode 7 when the heat-dissipating portion 8 is formed with a conductive material.

### Modification 2

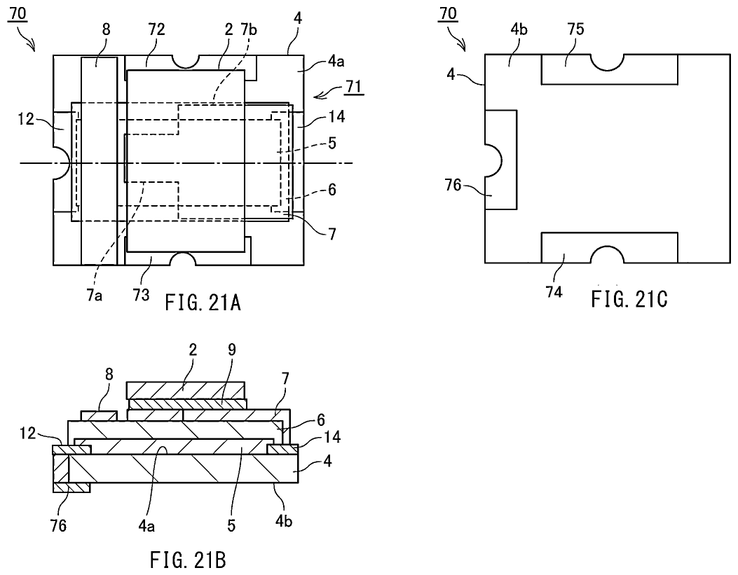

Although the above-described protecting devices 1 and 60 connect the blowing member 3 to the fuse element 2, the protecting device according to the present technology may have a structure in which the fuse element 2 is mounted on the insulating substrate 4 and the blowing member is surface-mounted on an external circuit board, as shown in FIG. 21. In the following description, the same symbols may be used for the same components as in the above-described protecting devices 1 and 60, and the details may be omitted.

The protecting device 70 shown in FIG. 21 has the fuse element 2 and a blowing member 71. The blowing member 71 includes the insulating substrate 4, the heat generator 5 formed on the front surface 4a side of the insulating substrate 4, the insulating layer 6 covering the heat generator 5, the heat-generator lead-out electrode 7 connected to the heat generator 5 and superimposed with the heat generator 5 via the insulating layer 6, and the heat-dissipating portion 8 formed on the front surface 4a side of the insulating substrate 4 at least in an area superimposed with the heat generator 5 and electrically independent from the heat-generator lead-out electrode 7, and a first electrode 72 and a second electrode 73 formed on the front surface 4a of the insulating substrate 4 and connected to an external circuit.

The fuse element 2 is connected to the first electrode 72, the second electrode 73, and the heat-generator lead-out electrode 7 provided between the first and second electrodes 72, 73 by a conductive connecting material such as the connecting solder 9.

The first and second electrodes 72, 73 are formed on both opposite edges of the front surface 4a of the insulating substrate 4. The insulating substrate 4 also includes the heat-generator feeding electrode 12 and the heat-generator electrode 14 formed on opposite side edges of the front surface 4a that are different from the side edges where the first and second electrodes 72, 73 are formed. As shown in FIG. 21C, the insulating substrate 4 includes first to third external connection electrodes 74 to 76 formed on the back surface 4b that are connected to an external circuit board.

The first and second electrodes 72, 73 are formed by conductive patterns such as Ag and Cu, respectively. On the surface of the first and second electrodes 72, 73, a coating such as Ni/Au plating, Ni/Pd plating, Ni/Pd/Au plating, or the like is preferably coated by a known method such as plating. This allows the protecting device 70 to prevent oxidation of the first and second electrodes 72, 73 and to prevent fluctuations in ratings due to increased conduction resistance. In addition, when reflow mounting the fuse element 2 to the first and second electrodes 72, 73 or reflow mounting the blowing member 71 to an external circuit board, the first and second electrodes 72, 73 can be prevented from eroding by melting the connecting solder 9 connecting the fuse element 2 (solder erosion).

The first electrode 72 is continuous with the first external connection electrode 74 formed on the back surface 4b via castration from the front surface 4a of the insulating substrate 4. The second electrode 73 is continuous with the second external connection electrode 75 formed on the back surface 4b via castration from the front surface 4a of the insulating substrate 4. In the blowing member 71, when the first and second external connection electrodes 74, 75 are connected to the connection electrodes on the external circuit board on which the blowing member 71 is mounted, the fuse element 2 is incorporated into part of the current path formed on the circuit board.

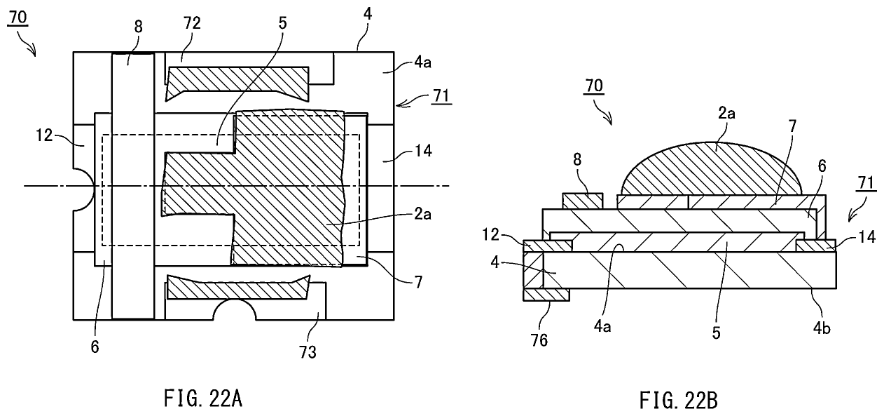

The first and second electrodes 72, 73 are electrically connected by the fuse element 2 being mounted with a conductive connecting material such as the connecting solder 9. As shown in FIG. 22, the first and second electrodes 72, 73 are interrupted when the heat generator 5 generates heat to blow the fuse element 2 as a result of energization. Alternatively, the first and second electrodes 72, 73 are interrupted when a rate-exceeding large current flows through the protecting device 70 and the fuse element 2 melts due to self-heating (Joule heat).

The blowing member 71 includes one heat generator 5 formed on the front surface 4a of the insulating substrate 4. The heat generator 5 is connected to the heat-generator feeding electrode 12 at one end and to the heat-generator electrode 14 at the other end. The heat-generator feeding electrode 12 is connected to one end of the heat generator 5 and serves as a terminal for supplying power to the heat generator 5, and is continuous with the third external connection electrode 76 formed on the back surface 4b of the insulating substrate 4 via castration. The heat-generator electrode 14 is connected to the heat-generator lead-out electrode 7.

The heat generator 5 is covered by the insulating layer 6 and superimposed with the heat-generator lead-out electrode 7 formed on the insulating layer 6. The heat-generator lead-out electrode 7 is connected to the fuse element 2, which is provided over the first and second electrodes 72, 73, via a bonding material such as the connecting solder 9.

The heat generator 5 is connected to a current control element or the like formed in an external circuit via the third external connection electrode 76 when the blowing member 71 is mounted on an external circuit board, and the current and heat generation are regulated under normal conditions. The heat generator 5 is energized via the third external connection electrode 76 to generate heat, at a predetermined time to interrupt the current path of the external circuit. The protecting device 70 can blow the fuse element 2 connecting the first and second electrodes 72, 73 by transferring heat of the heat generator 5 from the heat-generator electrode 14 through the heat-generator lead-out electrode 7 and through the insulating layer 6 and the heat-generator lead-out electrode 7, respectively, to the fuse element 2. As shown in FIG. 22, the melted conductor 2a of the fuse element 2 aggregates on the heat-generator lead-out electrode 7 and on the first and second electrodes 72, 73, thereby interrupting the current path between the first and second electrodes 72, 73. The heat generator 5 stops generating heat when the fuse element 2 is blown to interrupt the current path of the heat generator 5 itself.

The first and second electrodes 72, 73 and the heat-generator feeding electrode 12 are preferably provided with a regulatory wall (not shown) to prevent the connecting solder provided on the electrodes of the external circuit board connected to the first to third external connection electrodes 74 to 76 and melted during reflow mounting or the like from crawling up onto the first and second electrodes 72, 73 and the heat-generator feeding electrode 12 via the castellation and wetly spreading over these electrodes. The regulatory wall can be formed using insulating materials that do not have wettability to solder, such as glass, solder resist, or insulating adhesive, and can be formed by printing on the first and second electrodes 72, 73, and the heat-generator feeding electrode 12. The regulatory wall prevents the melted solder for connection from wetly spreading to the first and second electrodes 72, 73 and the heat-generator feeding electrode 12, thereby maintaining the connectivity between the blowing member 71 and the external circuit board.

### Heat-Dissipating Portion

The heat-dissipating portion 8 is formed electrically independent from the heat-generator lead-out electrode 7, at least in an area superimposed with the heat generator 5. For example, as shown in FIG. 21A, the heat-dissipating portion 8 is formed so as to cross the heat generator 5 on the heat-generator feeding electrode 12 side. The heat-dissipating portion 8 is provided on the insulating layer 6 and is separated from the heat-generator lead-out electrode 7 and the fuse element 2 connected to the heat-generator lead-out electrode 7. As a result, the heat-dissipating portion 8 is electrically independent from the power supply path to the heat generator 5 and the current path of the external circuit.

In the protecting device 70, as in the protecting devices 1 and 60, the heat-dissipating portion 8 absorbs heat from the heat generator 5, thereby reducing uneven heat distribution on the insulating substrate 4 and suppressing damage (thermal shock cracking) to the insulating substrate 4 and the heat generator 5 caused by the local concentration of heat from the heat generator 5.

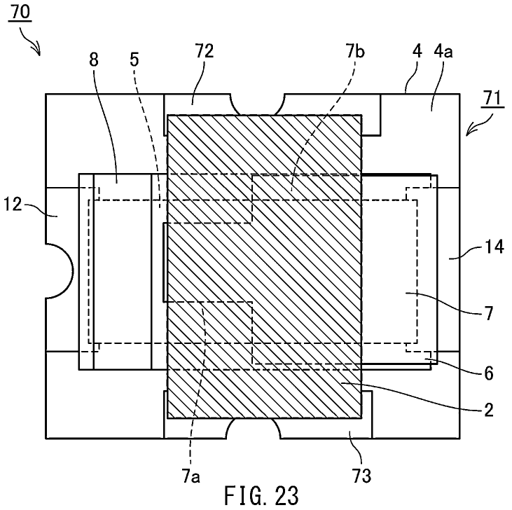

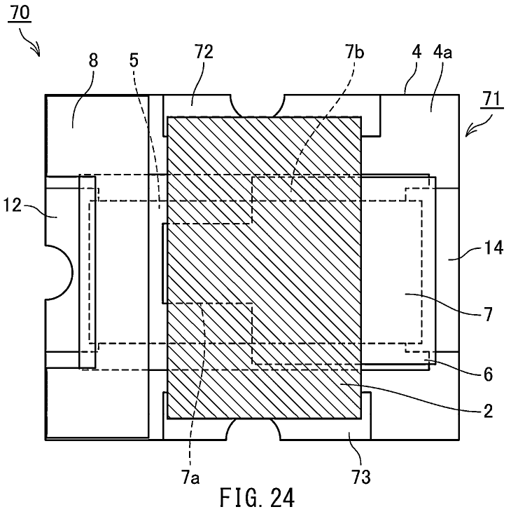

In the protecting device 70, the insulating coating layer 17 may also be formed to insulate and coat the heat-dissipating portion 8. In addition, the heat-dissipating portion 8 may be formed only on the insulating layer 6 as shown in FIG. 23 or may be formed as widely as possible by forming it from the area superimposed with the heat generator 5 to the area on the front surface 4a of the insulating substrate 4 where electrodes such as the heat-generator feeding electrode 12 are not formed, as shown in FIG. 24.

### Heat-Generator Lead-Out Electrode

The heat-generator lead-out electrode 7 is connected to the heat-generator electrode 14 at one end, is formed on the insulating layer 6, and is superimposed with the heat generator 5 via the insulating layer 6. As with the protecting device 1, the heat-generator lead-out electrode 7 includes the base portion 7b formed in a wide width and the tip portion 7a with a narrow width protruding from the base portion 7b.

By providing the wide base portion 7b of the heat-generator lead-out electrode 7, the capacity to hold the melted conductor 2a of the fuse element 2 can be increased on the base portion 7b side, thereby reliably blowing the fuse element 2 and reducing the risk of a short circuit between the heat-dissipating portion 8 provided at the tip portion 7a and the melted conductor 2a.

The heat-generator lead-out electrode 7 is mounted with the fuse element 2, and the tip portion 7a of the heat-generator lead-out electrode 7 preferably does not protrude toward the heat-generator feeding electrode 12 more than the side edge of the fuse element 2. Since the heat-generator feeding electrode 12 applied with a high voltage has a high potential, the heat-generator lead-out electrode 7 can be separated from the high potential part by evacuating the heat-generator lead-out electrode 7 from the fuse element 2 to the low potential part. If the tip portion 7a of the heat-generator lead-out electrode 7 protrudes from the side edge of the fuse element 2 toward the heat-generator feeding electrode 12, there is a risk that the tip portion 7a may act as a lightning rod, but this type of lightning rod-like part is not formed in this configuration, thereby reducing the risk of spark generation. Furthermore, the superposition of the heat-generator lead-out electrode 7 and the fuse element 2 increases the volume of the metal (i.e., the tip portion 7a and the fuse element 2) facing the heat-generator feeding electrode 12 having a high potential, and improves the resistance to impact and prevents damage in the event of a spark.

### Circuit Configuration

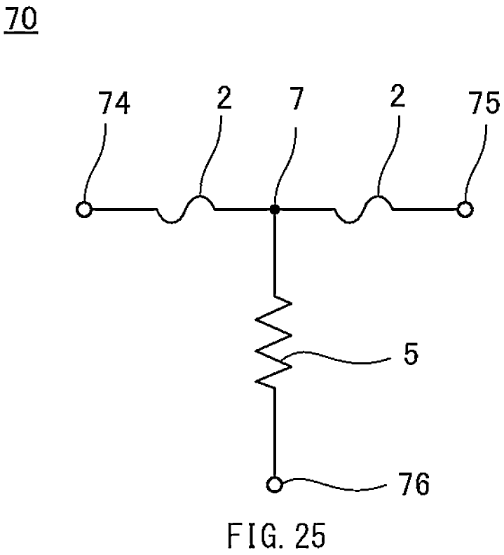

FIG. 25 is a circuit diagram of the protecting device 70. When the protecting device 70 is used as the protecting device for the battery pack 40 shown in FIG. 13, the first external connection electrode 74 is connected to the battery stack 45 side, and the second external connection electrode 75 is connected to the positive electrode terminal 40a side, thereby connecting the fuse element 2 in series on the charging/discharging path of the battery stack 45. In the protecting device 70, the heat generator 5 is connected to the current control element 48 via the heat-generator feeding electrode 12 and the third external connection electrode 76, and the heat generator 5 is also connected to the open end of the battery stack 45. Thus, one end of the heat generator 5 is connected to the fuse element 2 and one open end of the battery stack 45 via the heat-generator lead-out electrode 7 and the other end of the heat generator 5 is connected to the current control element 48 and the other open end of the battery stack 45 via the third external connection electrode 76, forming a power supply path to the heat generator 5, the energization of which is controlled by the current control element 48.

The connection between the protecting device 70 and an external circuit, such as a battery circuit, can be made, e.g., by mounting the blowing member 71 on an external circuit board by reflow mounting or the like. In other words, the blowing member 71 is mounted on the external circuit board by having the first to third external connection electrodes 74 to 76 formed on the back surface 4b of the insulating substrate 4 mounted on the lands provided at predetermined mounting positions on the external circuit board via connecting material such as connection solder and then passed through a reflow oven. The fuse element 2 is thus incorporated in the current path of the external circuit.

### Operation of Protecting Device

Upon detecting an abnormal voltage in any of the battery cells 41a to 41d, the detection circuit 47 outputs an interruption signal to the current control element 48. The current control element 48 then controls the current to energize the heat generator 5. The protecting device 70 causes current to flow from the battery stack 45 to the heat generator 5, which causes the heat generator 5 to begin generating heat. The protecting device 70 interrupts the charging/discharging path of the battery stack 45 by blowing the fuse element 2 with the heat generated by the heat generator 5 (FIG. 22). In the protecting device 70, by forming the fuse element 2 with a high-melting-point metal and a low-melting-point metal, the low-melting-point metal melts before melting the high-melting-point metal, and the fuse element 2 can be blown in a short time by utilizing the erosive action on the high-melting-point metal by the melted low-melting-point metal.

Here, in the protecting device 70, the heat-dissipating portion 8 absorbs heat from the heat generator 5, thereby reducing uneven heat distribution on the insulating substrate 4 and suppressing damage (thermal shock cracking) to the insulating substrate 4 and the heat generator 5 caused by the local concentration of heat from the heat generator 5. Furthermore, in the protecting device 70, since the heat-dissipating portion 8 formed between the tip portion 7a of the heat-generator lead-out electrode 7 and the heat-generator feeding electrode 12 is electrically independent from the heat-generator lead-out electrode 7, it is possible to suppress the occurrence of sparks (insulation breakdown) between the tip portion 7a of the heat-generator lead-out electrode 7 and the heat-generator feeding electrode 12. As a result, the protecting device 70 can safely and quickly blow the fuse element 2 and interrupt the current path even when a high voltage is applied to the heat generator 5 from the battery stack 45 for high-current applications.

When the fuse element 2 is blown, the protecting device 70 also interrupts the power supply path to the heat generator 5, thereby stopping the heating of the heat generator 5.

In addition, when a rate-exceeding overcurrent flows through the fuse element 2, the protecting device 70 can blow the fuse element 2 by self-heating to interrupt the charging/discharging path of the battery pack 40.

Thus, in the protecting device 70, the fuse element 2 is blown by the heat generated by the energization of the heat generator 5 or by the self-heating of the fuse element 2 due to the overcurrent. Here, in the protecting device 70, when the fuse element 2 is reflow-mounted on the insulating substrate 4, when the blowing member 71 is reflow-mounted on the circuit board, or when the circuit board on which the protecting device 70 is mounted is further exposed to a high temperature environment such as reflow heating, the deformation of the fuse element 2 is suppressed by forming the fuse element 2 in a configuration in which the low-melting-point metal is covered by the high-melting-point metal. This prevents fluctuations in blowout properties caused by resistance fluctuations due to the deformation of the fuse element 2, thereby quickly blowing the fuse element 2 by a predetermined overcurrent or heat generated by the heat generator 5.

### Modification 3

In the above-described protecting device 70, the first and second electrodes 72, 73 and the heat-generator lead-out electrode 7 are formed on the front surface 4a of the insulating substrate 4 on which the heat generator 5 is formed and the fuse element 2 is mounted thereon, but each electrode 72, 73, 7 and the fuse element 2 may be formed on the back surface 4b of the insulating substrate 4. In the following description, the same components as the above-described protecting devices 1, 60, and 70 may be denoted by the same reference numerals and the details thereof may be omitted.

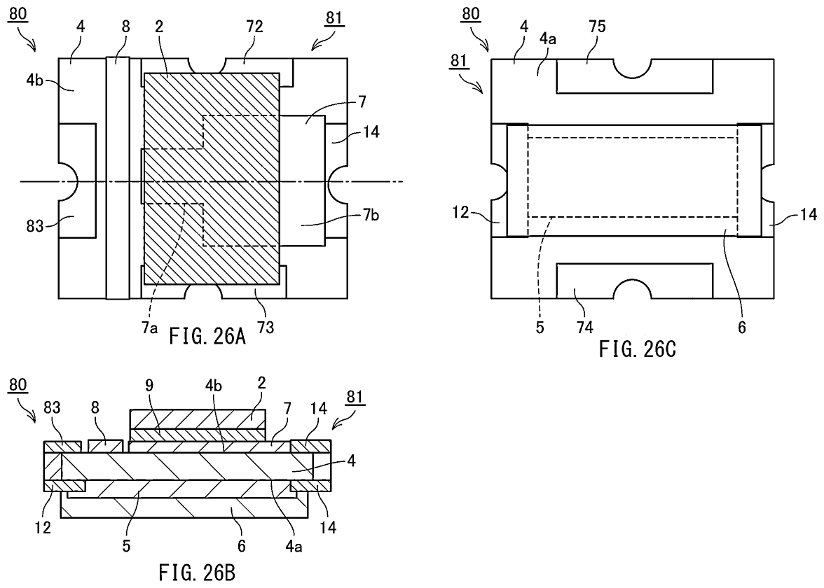

The protecting device 80 shown in FIG. 26 includes the fuse element 2 and a blowing member 81. In the blowing member 81, the heat-generator feeding electrode 12, the heat-generator electrode 14, the heat generator 5, the insulating layer 6, the first external connection electrode 74, and the second external connection electrode 75 are formed on the front surface 4a of the insulating substrate 4. In addition, the protecting device 80, the heat-generator electrode 14, the heat-generator lead-out electrode 7, the first electrode 72, the second electrode 73, and the heat-dissipating portion 8 are formed on the back surface 4b of the insulating substrate 4, and the fuse element 2 is mounted from the first electrode 72 through the heat-generator lead-out electrode 7 to the second electrode 73.

The heat-generator electrodes 14 are formed on the front surface 4a and back surface 4b of the insulating substrate 4, respectively, and both heat-generator electrodes 14 are electrically connected via castration. The heat-generator lead-out electrode 7 is electrically connected to the heat generator 5 provided on the front surface 4a of the insulating substrate 4 via the heat-generator electrodes 14 provided on the front surface 4a and back surface 4b of the insulating substrate 4. In the protecting device 80, the front surface 4a of the insulating substrate 4 is the mounting surface to the external circuit board, and the heat-generator feeding electrode 12, the first external connection electrode 74, and the second external connection electrode 75 are connected via connecting solder or other connecting material to the land provided at a predetermined mounting position on the external circuit board.

In the protecting device 80 as well, the heat-dissipating portion 8 is also formed electrically independent from the heat-generator lead-out electrode 7 at least in an area superimposed with the heat generator 5 via the insulating substrate 4. For example, the heat-dissipating portion 8 is formed so as to cross the heat generator 5 on the heat-generator feeding electrode 12 side of the insulating substrate 4 between the two side edges where the first and second electrodes 72, 73 are provided respectively. In addition, the heat-dissipating portion 8 which is provided separately from the heat-generator lead-out electrode 7 and the fuse element 2 connected to the heat-generator lead-out electrode 7, is electrically independent from the power supply path to the heat generator 5 and the current path of the external circuit.

In the protecting device 80 as well, by forming the heat-dissipating portion 8, heat generated by the heat generator 5 is absorbed from the back surface 4b of the insulating substrate 4. Therefore, uneven heat distribution on the insulating substrate 4 is reduced, thereby suppressing damage (thermal shock cracking) to the insulating substrate 4 and the heat generator 5 caused by the local concentration of heat from the heat generator 5 in areas where the heat-generator lead-out electrode 7 is not formed.

The back surface 4b of the insulating substrate 4 is provided with a guiding electrode 83 connected to the heat-generator feeding electrode 12 via a castellation. The guiding electrode 83 guides the connecting solder that connects the heat-generator feeding electrode 12 to the land to wetly spread over the entire wall surface of the castration.

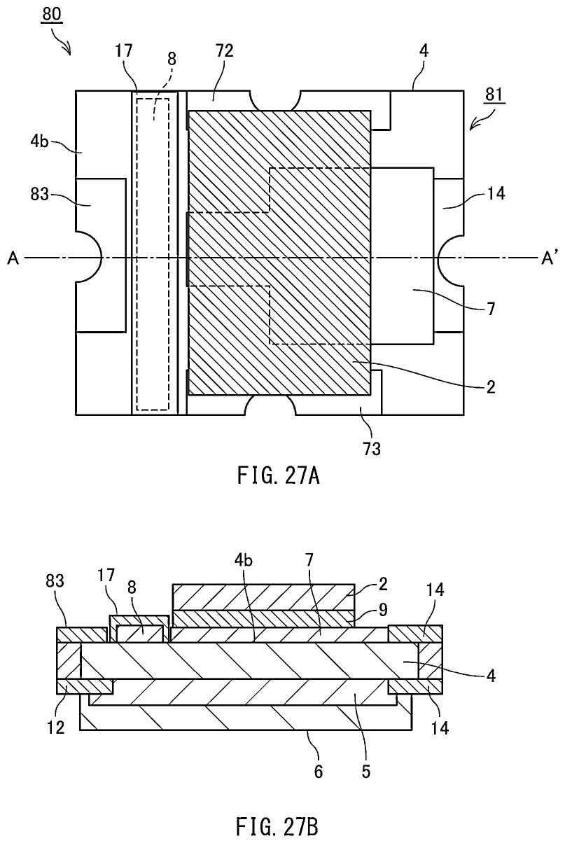

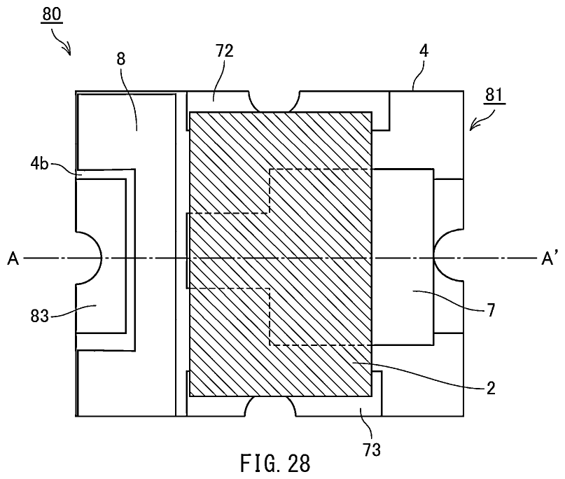

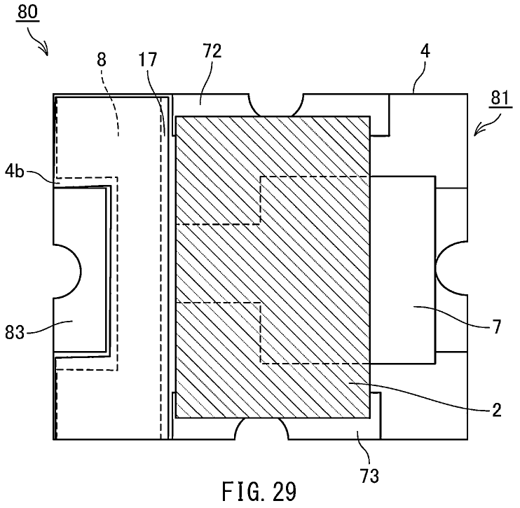

As shown in FIG. 27, the insulating coating layer 17 may also be formed on the protecting device 80 to insulate and cover the heat-dissipating portion 8. In addition, the heat-dissipating portion 8 may be formed as widely as possible by forming it from the area superimposed with the heat generator 5 to the side edge where the heat-generator feeding electrode 12 is formed, as shown in FIG. 28. FIG. 29 is a plan view of a configuration in which the heat-dissipating portion 8 is widened as much as possible and the heat-dissipating portion 8 is covered with an insulating coating layer 17.

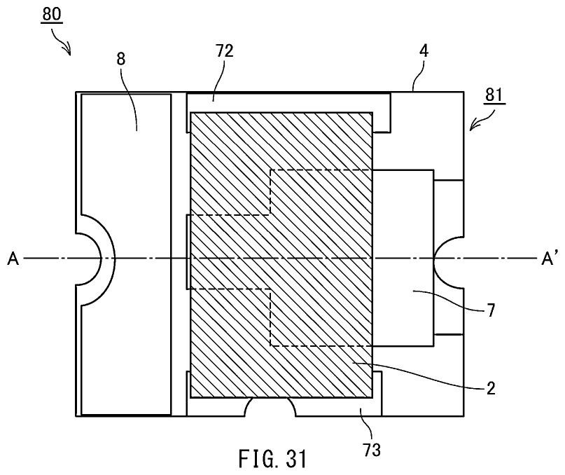

As shown in FIG. 31, the guiding electrode 83 may not be formed, and alternatively, the heat-dissipating portion 8 may be widened as much as possible. In this case, the heat-dissipating portion 8 is separated from the castellation and maintains electrical independence. Also in this configuration, the heat-dissipating portion 8 may be covered with an insulating coating layer 17.

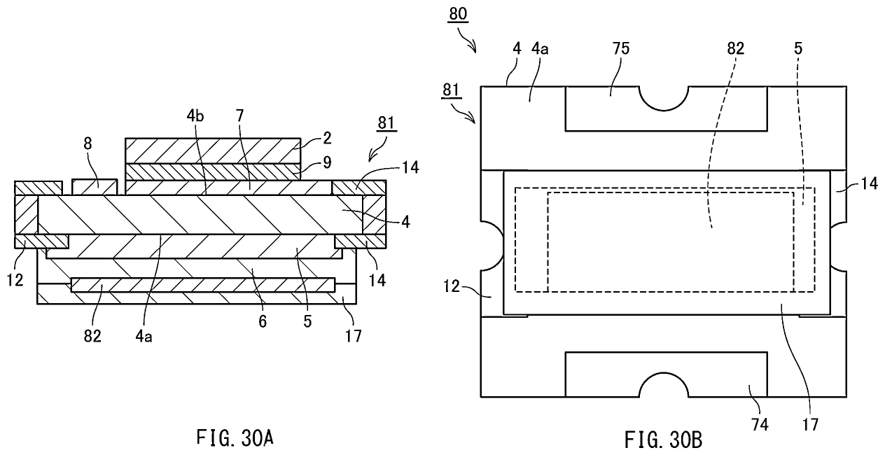

Furthermore, the protecting device 80 may have a second heat-dissipating portion 82 on the front surface 4a of the insulating substrate 4. As shown in FIG. 30, the second heat-dissipating portion 82 can be formed using the same material and the same method as the heat-dissipating portion 8, and is formed on the insulating layer 6 to be superimposed with the heat generator 5. The second heat-dissipating portion 82 is covered by the insulating coating layer 17. The second heat-dissipating portion 82 also absorbs heat from the heat generator 5, thereby reducing the amount of heat transmitted to the insulating substrate 4, preventing overheating of the heat generator 5 itself, and suppressing damage (thermal shock cracking) to the insulating substrate 4 and the heat generator 5.

### Modification 4

A protecting device with a configuration in which the blowing member is surface-mounted on an external circuit board may be equipped with a plurality of heat generators on the front surface 4a of the insulating substrate 4. In the following description, the same components as the above-described protecting devices 1, 60, 70, and 80 may be denoted by the same reference numerals and the details thereof may be omitted.

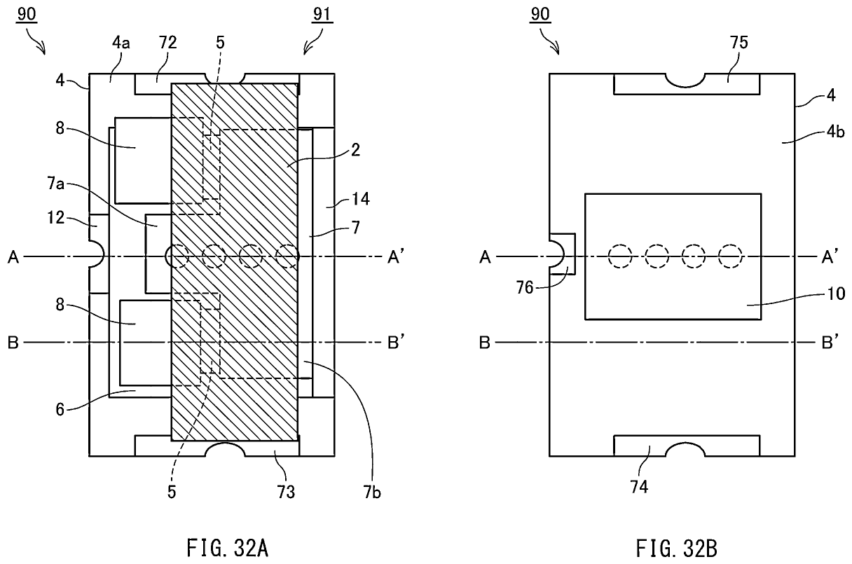

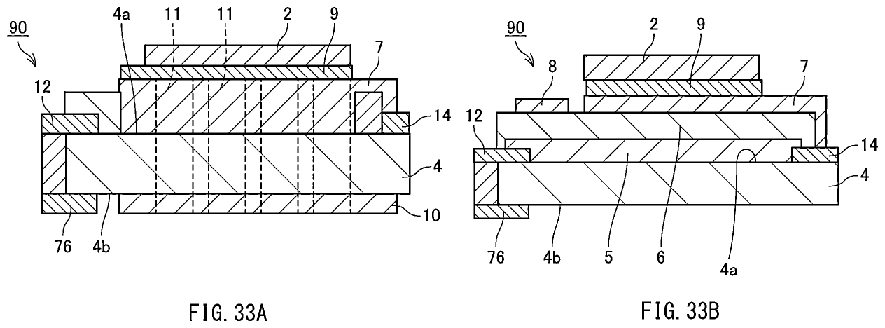

The protecting device 90 shown in FIG. 32 includes the fuse element 2 and a blowing member 91. The blowing member 91 has a plurality of heat generators 5 spaced apart and in parallel on the front surface 4a of the insulating substrate 4. As with the protecting device 70, the first and second electrodes 72, 73, the heat-generator lead-out electrode 7, the heat-generator feeding electrode 12, and the heat-generator electrode 14 are formed on the front surface 4a of the insulating substrate 4, and the first to third external connection electrodes 74-76 are formed on the back surface 4b of the insulating substrate 4. In addition, the protecting device 90 includes the holding electrode 10 formed on the back surface 4b of the insulating substrate 4. As shown in FIG. 33, the insulating substrate 4 is provided with the through-hole 11 formed in the area between the parallel heat generators 5, which is the area where the heat generators 5 are not formed, to connect the heat-generator lead-out electrode 7 formed on the front surface 4a and the holding electrode 10 formed on the back surface 4b. It should be noted that FIG. 33A is a cross-sectional view taken along line A-A′ of FIG. 32A, and FIG. 33B is a cross-sectional view taken along line B-B′ of FIG. 32A.

Each of the heat generators 5 is connected to the heat-generator feeding electrode 12 at one end and to the heat-generator electrode 14 at the other end. The heat-generator electrode 14 is connected to the heat-generator lead-out electrode 7. Each of the heat generators 5 is covered by the insulating layer 6 and superimposed with the heat-generator lead-out electrode 7 formed on the insulating layer 6.

The configuration of the heat generators 5, the insulating layer 6, and the heat-generator lead-out electrode 7 is the same as that of the blowing member 3 described above. In other words, the heat-generator lead-out electrode 7 includes the tip portion 7a that extends between the heat generators 5, a region where the heat generators 5 are not formed, and the base portion 7b that connects to the heat-generator electrode 14.

The configuration and action of the heat-dissipating portion 8 are the same as that of the blowing member 3 described above. The heat-dissipating portion 8 may be formed only on the insulating layer 6 or may be formed as widely as possible, such as from the area superimposed with the heat generator 5 to the side edge where the heat-generator feeding electrode 12 is formed (see FIGS. 2, 8, and 6). In the protecting device 90, the heat-dissipating portion 8 is preferably covered with an insulating coating layer 17. In the protecting device 90 as well, the heat-dissipating portion 8 absorbs the heat of the heat generator 5, thereby reducing the uneven heat distribution on the insulating substrate 4 and suppressing damage (thermal shock cracking) to the insulating substrate 4 and the heat generator 5 caused by the local concentration of heat from the heat generator 5.

The fuse element 2 is connected to the first electrode 72, the second electrode 73, and the heat-generator lead-out electrode 7 provided between the first and second electrodes 72, 73 by a conductive connecting material such as the connecting solder 9.

### Circuit Configuration

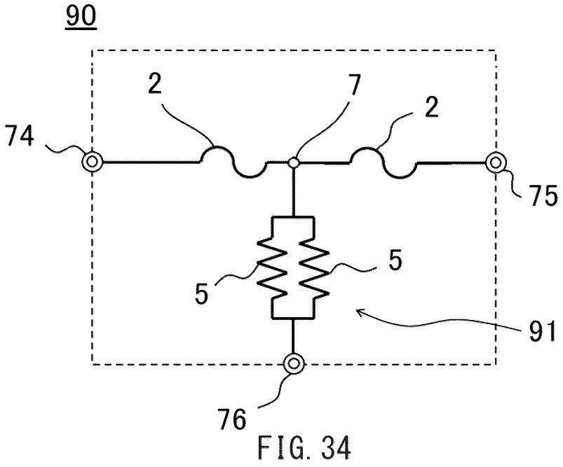

FIG. 34 is a circuit diagram of the protecting device 90 shown in FIG. 32. When the protecting device 90 is used as the protecting device of the battery pack 40 shown in FIG. 13, the first external connection electrode 74 is connected to the battery stack 45 side and the second external connection electrode 75 is connected to the positive electrode terminal 40a side, thereby connecting the fuse element 2 in series on the charging/discharging path of the battery stack 45. In the protecting device 90, the heat generator 5 is connected to the current control element 48 via the heat-generator feeding electrode 12 and the third external connection electrode 76, and the heat generator 5 is connected to the open end of the battery stack 45. Thus, one end of the heat generator 5 is connected to the fuse element 2 and one open end of the battery stack 45 via the heat-generator lead-out electrode 7 and the other end of the heat generator 5 is connected to the current control element 48 and the other open end of the battery stack 45 via the third external connection electrode 76, forming a power supply path to the heat generator 5, the energization of which is controlled by the current control element 48.

The connection between the protecting device 90 and an external circuit, such as a battery circuit, can be made, e.g., by mounting the blowing member 91 on an external circuit board by reflow mounting or the like. In other words, the blowing member 91 is mounted on the external circuit board by having the first to third external connection electrodes 74 to 76 formed on the back surface 4b of the insulating substrate 4 mounted on the lands provided at predetermined mounting positions on the external circuit board via connecting materials such as connection solder and then passed through a reflow oven. The fuse element 2 is thus incorporated in the current path of the external circuit.

### Operation of Protecting Device

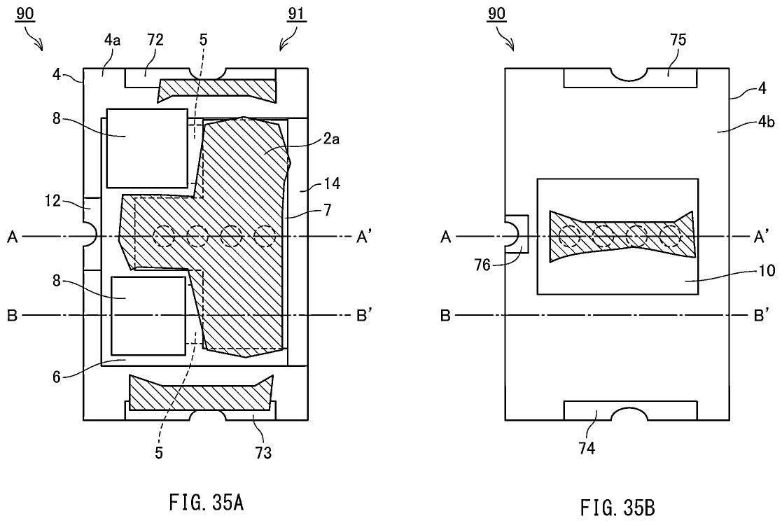

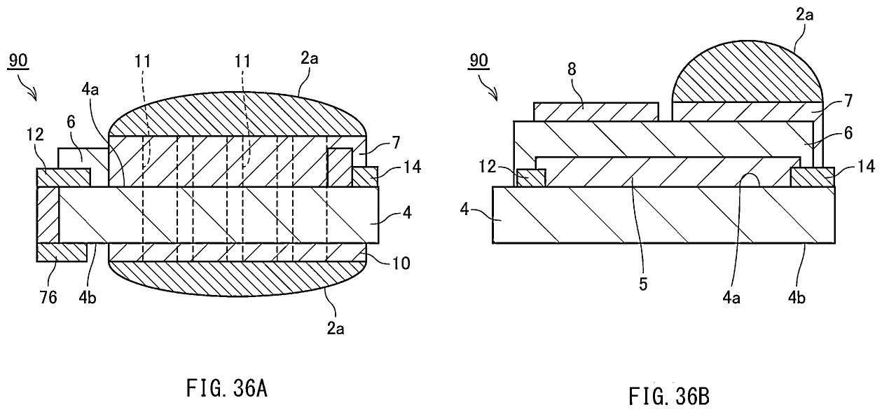

When a current flows from the external circuit to the heat generator 5 and the heat generator 5 begins to generate heat, the fuse element 2 is blown by the heat generated by the heat generator 5 and interrupts the current path of the external circuit, as shown in FIG. 35. As shown in FIG. 36, the melted conductor 2a of the fuse element 2 is held by the heat-generator lead-out electrode 7, and a part of it is sucked into the through-hole 11 opened in the heat-generator lead-out electrode 7 and held by the holding electrode 10 formed on the back surface 4b of the insulating substrate 4. It should be noted that FIG. 36A is a cross-sectional view taken along line A-A′ of FIG. 35, and FIG. 36B is a cross-sectional view taken along line B-B′ of FIG. 35.

Here, in the protecting device 90, the heat-dissipating portion 8 absorbs the heat of the heat generator 5, thereby reducing the uneven heat distribution on the insulating substrate 4 and suppressing damage (thermal shock cracking) to the insulating substrate 4 and the heat generator 5 caused by the localized heat concentration of the heat generator 5. Furthermore, in the protecting device 90, since the heat-dissipating portion 8 formed between the heat-generator lead-out electrode 7 and the heat-generator feeding electrode 12 is electrically independent from the heat-generator lead-out electrode 7, it is possible to suppress the occurrence of sparks (insulation breakdown) between the heat-generator lead-out electrode 7 and the heat-generator feeding electrode 12. As a result, the protecting device 90 can safely and quickly blow the fuse element 2 and interrupt the current path even when a high voltage is applied to the heat generator 5.

When the fuse element 2 is blown, the protecting device 90 also interrupts the power supply path to the heat generator 5, thereby stopping the heating of the heat generator 5.

In addition, when a rate-exceeding overcurrent flows through the fuse element 2, the protecting device 90 can also blow the fuse element 2 by self-heating to interrupt the current path of the external circuit.

### Modification 5

In the above-described protecting device 90, the first and second electrodes 72, 73 and the heat-generator lead-out electrode 7 are formed on the front surface 4a of the insulating substrate 4 on which the heat generator 5 is formed and the fuse element 2 is mounted thereon, but each of the electrodes 72, 73 and the fuse element 2 may be formed on the back surface 4b of the insulating substrate 4. In the following description, the same components as the above-described protecting devices 1, 60, 70, 80, and 90 may be denoted by the same reference numerals and the details thereof may be omitted.

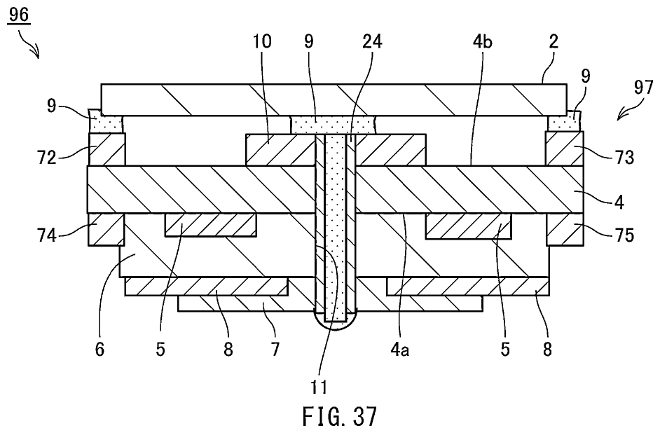

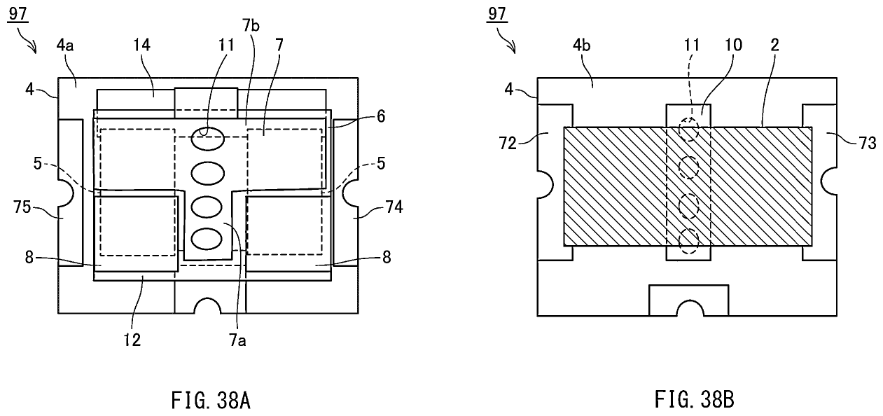

The protecting device 96 shown in FIG. 37 includes the fuse element 2 and a blowing member 97. As shown in FIG. 38, in the blowing member 97, the heat-generator feeding electrode 12, the heat-generator electrode 14, the heat generator 5, the insulating layer 6, the heat-generator lead-out electrode 7, the first external connection electrode 74, and the second external connection electrode 75, and the heat-dissipating portion 8 are formed on the front surface 4a of the insulating substrate 4.

In the protecting device 96, the first electrode 72, the second electrode 73, and the holding electrode 10 are formed on the back surface 4b of the insulating substrate 4, and the fuse element 2 is mounted from the first electrode 72 through the holding electrode 10 to the second electrode 73. The holding electrode 10 is continuous with the heat-generator lead-out electrode 7 through the through-hole 11.

The heat-generator electrode 14 and the heat-generator lead-out electrode 7 provided on the front surface 4a of the insulating substrate 4 are electrically connected. In the protecting device 96, the front surface 4a of the insulating substrate 4 is the mounting surface to the external circuit board, and the heat-generator feeding electrode 12, the first external connection electrode 74, and the second external connection electrode 75 are connected via connecting solder or other connecting material to the land provided at a predetermined mounting position on the external circuit board.

In the protecting device 96 as well, the heat-dissipating portion 8 is also formed electrically independent from the heat-generator lead-out electrode 7 at least in an area superimposed with the heat generator 5 via the insulating layer 6. The heat-dissipating portion 8, which is provided separately from the heat-generator lead-out electrode 7 and the first and second external connection electrodes 74, 75, is electrically independent from the power supply path to the heat generator 5 and the current path of the external circuit.

In the protecting device 96 as well, the heat-dissipating portion 8 superimposed with the heat generator 5 absorbs the heat of the heat generator 5. Therefore, uneven heat distribution on the insulating substrate 4 is reduced, thereby suppressing damage (thermal shock cracking) to the insulating substrate 4 and the heat generator 5 caused by the local concentration of heat from the heat generator 5 in areas where the heat-generator lead-out electrode 7 is not formed.

In the protecting device 96, the insulating coating layer 17 may also be formed to insulate and coat the heat-dissipating portion 8. The heat-dissipating portion 8 may be formed as widely as possible, such as from the area superimposed with the heat generator 5 to the area where electrodes such as the heat-generator feeding electrode 12 are not formed.

### REFERENCE SIGNS LIST

1 protecting device, 2 fuse element,2a melted conductor, 3 blowing member, 4 insulating substrate, 5 heat generator, 6 insulating layer, 7 heat-generator lead-out electrode, 7a tip portion, 7b base portion, 8 heat-dissipating portion, 9 connecting solder, 10 holding electrode, 11 through-hole, 12 heat-generator feeding electrode, 14 heat-generator electrode, 15 auxiliary electrode, 17 insulating coating layer, 20 screw hole, 21 first electrode terminal, 22 second electrode terminal, 23 third electrode terminal, 24 conductive layer, 26 low-melting-point metal layer, 27 high-melting-point metal layer, 28 case, 29 upper case, 30 lower case, 30a side edge portion, 30b hollow portion, 40 battery pack, 40a positive electrode terminal, 40b negative electrode terminal, 41 battery cell, 42 charging device, 43 current control element, 44 control unit, 45 battery stack, 46 charge/discharge control circuit, 47 detection circuit, 48 current control element, 50 protruding portion, 51 heat-dissipating element, 60 protecting device, 70 protecting device, 71 blowing member, 72 first electrode, 73 second electrode, 74 first external connection electrode, 75 second external connection electrode, 76 third external connection electrode, 80 protecting device, 81 blowing member, 82 second heat-dissipating portion, 90 protecting device, 91 blowing member, 96 protecting device, 97 blowing member, 100 protecting device, 101 fuse element, 102 blowing member, 103 insulating substrate, 104 heat generator, 105 insulating layer, 106 heat-generator lead-out electrode, 107 holding electrode, 108 through-hole, 109 auxiliary electrode, 110 heat-generator feeding electrode, 111 first electrode terminal, 112 second electrode terminal, 114 connecting solder,

1. A protecting device comprising:
a fuse element and a blowing member for blowing the fuse element, wherein
the blowing member comprises:
an insulating substrate;
a heat generator formed on the front surface of the insulating substrate;
an insulating layer covering the heat generator;
a heat-generator lead-out electrode connected to the heat generator and superimposed with the heat generator via the insulating layer;
a heat-dissipating portion formed on the front surface of the insulating substrate, at least in an area superimposed with the heat generator, and electrically independent from the heat-generator lead-out electrode;
a holding electrode formed on the back surface of the insulating substrate that is the reverse side of the front surface to hold the melted conductor of the fuse element when the fuse element is blown; and
a through-hole connecting the heat-generator lead-out electrode and the holding electrode, wherein
the fuse element is connected to the holding electrode.

2. A protecting device comprising:
a fuse element and a blowing member for blowing the fuse element, wherein
the blowing member comprises:
an insulating substrate;
a heat generator formed on the front surface of the insulating substrate;
an insulating layer covering the heat generator;
a heat-generator lead-out electrode connected to the heat generator and superimposed with the heat generator via the insulating layer;
a heat-dissipating portion formed on the front surface of the insulating substrate, at least in an area superimposed with the heat generator, and electrically independent from the heat-generator lead-out electrode;
a holding electrode formed on the back surface of the insulating substrate that is the reverse side of the front surface to hold the melted conductor of the fuse element when the fuse element is blown; and
a through-hole connecting the heat-generator lead-out electrode and the holding electrode, wherein
the fuse element is connected to the heat-generator lead-out electrode.

3. The protecting device according to claim 1- or 2, comprising
a plurality of the blowing members, wherein
the blowing members are connected to one side of the fuse element and to the other side opposite to the one side.

4. The protecting device according to claim 3, wherein the blowing members are at a position facing each other via the fuse element.

5. A protecting device comprising:
a fuse element and a blowing member for blowing the fuse element, wherein
the blowing member comprises:
an insulating substrate;
a heat generator formed on the front surface of the insulating substrate;
an insulating layer covering the heat generator;
a heat-generator lead-out electrode connected to the heat generator and superimposed with the heat generator via the insulating layer;
a heat-dissipating portion formed on the front surface of the insulating substrate, at least in an area superimposed with the heat generator, and electrically independent from the heat-generator lead-out electrode; and
a first electrode and a second electrode formed on the front surface of the insulating substrate and connected to an external circuit, wherein
the fuse element is connected to the first electrode, the second electrode, and the heat-generator lead-out electrode provided between the first and second electrodes.

6. The protecting device according to claim 5, wherein a plurality of the heat generators are provided in parallel on the front surface of the insulating substrate.

7. A protecting device according to claim 6, comprising:
a holding electrode formed on the back surface that is the reverse side of the front surface of the insulating substrate and holding the melted conductor of the fuse element when the fuse element is blown; and
a through-hole penetrating the area between the plurality of heat generators and connecting the heat-generator lead-out electrode and the holding electrode.

8. A protecting device comprising:
a fuse element and a blowing member for blowing the fuse element, wherein
the blowing member comprises:
an insulating substrate;
a heat generator formed on the front surface of the insulating substrate;
an insulating layer covering the heat generator;
a heat-generator lead-out electrode superimposed with the heat generator on the back surface of the insulating substrate and connected to the heat generator;
a heat-dissipating portion formed on the back surface of the insulating substrate at least in an area superimposed with the heat generator, and electrically independent from the heat-generator lead-out electrode; and
a first electrode and a second electrode formed on the back surface of the insulating substrate and connected to an external circuit, wherein
the fuse element is connected to the first electrode, the second electrode, and the heat-generator lead-out electrode.

9. A protecting device comprising:
a fuse element and a blowing member for blowing the fuse element, wherein
the blowing member comprises:
an insulating substrate;
a plurality of heat generators provided in parallel on the front surface of the insulating substrate;
an insulating layer covering the heat generators;
a heat-generator lead-out electrode connected to the heat generators and superimposed with the heat generators via the insulating layer;
a heat-dissipating portion formed on the front surface of the insulating substrate, at least in an area superimposed with the heat generators, and electrically independent from the heat-generator lead-out electrode;
a first electrode and a second electrode formed on the back surface of the insulating substrate and connected to an external circuit;
a holding electrode provided between the first and second electrodes on the back surface of the insulating substrate;
a through-hole penetrating the area between the plurality of heat generators of the insulating substrate and connecting the heat-generator lead-out electrode and the holding electrode, wherein
the fuse element is connected to the first electrode, the second electrode, and the holding electrode.

10. The protecting device according to claim 1, wherein the heat-dissipating portion is formed of conductive material.

11. The protecting device according to claim 10 further comprising an insulating coating layer covering the heat-dissipating portion.

12. The protecting device according to claim 1, wherein the heat-dissipating portion is formed over the front surface and side surfaces of the insulating layer.

13. The protecting device according to claim 1, wherein the heat-dissipating portion is formed as widely as possible over the area superimposed with the heat generator and over the electrode-free area of the insulating substrate.

14. The protecting device according to claim 1, further comprising:
a case for accommodating the blowing member and the fuse element, wherein
the case is formed with a protruding portion that contacts the heat-dissipating portion and absorbs heat.

15. The protecting device according to claim 1, wherein the heat-dissipating portion is provided with a heat-dissipating element that dissipates the heat of the heat-dissipating portion.

16. A battery pack, comprising: one or more battery cells;
and a protecting device connected on a charging/discharging path of the battery cells to interrupt the charging/discharging path, wherein
the protecting device is the protecting device according to claim 1.

17. The protecting device according to claim 2, comprising
a plurality of the blowing members, wherein
the blowing members are connected to one side of the fuse element and to the other side opposite to the one side.

18. The protecting device according to claim 17, wherein the blowing members are at a position facing each other via the fuse element.
